(19) United States
(12) Patent Application Publication
(10) Pub. No.: US 2025/0358487 A1
(43) Pub. Date: Nov. 20, 2025

(54) ELECTRONIC DEVICE AND SHOOTING MANAGEMENT METHOD

(71) Applicant: Panasonic Intellectual Property Management Co., Ltd., Osaka (JP)

(72) Inventors: Shohei KANNO, Hyogo (JP); Toshinari SUO, Osaka (JP); Takayoshi SHIMODA, Osaka (JP); Kaito KANDA, Osaka (JP)

(73) Assignee: Panasonic Intellectual Property Management Co., Ltd., Osaka (JP)

(21) Appl. No.: 19/205,188

(22) Filed: May 12, 2025

(30) Foreign Application Priority Data
May 14, 2024 (JP) 2024-078766

(51) Int. Cl. H04N 21/81; H04N 21/431; H04N 21/854; H04N 23/69

(52) U.S. Cl. CPC H04N 21/8113; H04N 21/4318; H04N 21/854; H04N 23/69

(57) ABSTRACT

An electronic device is provided for managing video shooting in accordance with a music track. The electronic device includes: a display that displays information; an input interface that inputs a user operation; and a controller that generates management information managing a video associated with audio data indicating the music track. The controller causes the display to display a time range within the music track indicated by the audio data and the input interface to receive the user operation setting a shooting unit for the management information, the shooting unit during which a video is shot for the time range within the music track. The controller generates the management information by associating the time range within the music track with the shooting unit set by the user operation.

### TECHNICAL FIELD

The present disclosure relates to an electronic device and a shooting management method for managing video shooting in accordance with a music track.

### BACKGROUND ART

JP 2010-103659 A discloses a video recording device that records video data according to a flow of music. In a case where one section in the music divided into a plurality of sections is designated, the video recording device stores video data in association with the designated section and the playback position of the music, the video data representing a video shot by a camera while playing back the music in the designated section. The video recording device continuously plays back the video data stored for each section simultaneously with the playback of the music over the plurality of sections. In this way, the video recording device of JP 2010-103659 A aims to easily create video data over the entire music even for long music.

### SUMMARY

The present disclosure provides an electronic device and a shooting management method that can facilitate management of video shooting in accordance with a music track.

In the present disclosure, an electronic device is provided for managing video shooting in accordance with a music track. The electronic device includes: a display that displays information; an input interface that inputs a user operation; and a controller that generates management information managing a video associated with audio data indicating the music track. The controller causes the display to display a time range within the music track indicated by the audio data and the input interface to receive the user operation setting a shooting unit for the management information, the shooting unit during which a video is shot for the time range within the music track. The controller generates the management information by associating the time range within the music track with the shooting unit set by the user operation.

In the present disclosure, a shooting management method is a method for managing video shooting in accordance with a music track. The method includes generating, by a controller of an electronic device, management information managing a video associated with audio data indicating the music track. The controller controls a display that displays information and an input interface that inputs a user operation. In the shooting management method, generating the management information includes: causing the display to display a time range within the music track indicated by the audio data and the input interface to receive a user operation setting a shooting unit for the management information, the shooting unit during which a video is shot for the time range within the music track; and generating the management information by associating the time range within the music track with the shooting unit set by the user operation.

In another aspect of the present disclosure, an electronic device is provided for managing video shooting in accordance with a music track. The electronic device includes: an image sensor that captures a subject image to generate video data; a memory that stores management information managing a video associated with audio data indicating the music track; and a controller that controls the video shooting by the image sensor. The management information includes a time range within the music track in association with a shooting unit set to shoot a video for the time range within the music track indicated by the audio data. The controller controls the video shooting in the shooting unit based on the management information.

In another aspect of the present disclosure, an electronic device is provided for managing video shooting in accordance with a music track. The electronic device includes: a display that displays information; an input interface that inputs a user operation; a controller that controls the display and the input interface; and a memory that stores management information managing a video associated with audio data indicating the music track. The management information includes a time range within the music track in association with a shooting unit set to shoot a video for the time range within the music track indicated by the audio data. The controller causes the display to display a video shot in the shooting unit, based on the management information, and the input interface to receive a user operation editing the video associated with the audio data.

According to the electronic device and the shooting management method of the present disclosure, it is possible to facilitate management of video shooting in accordance with a music track.

### BRIEF DESCRIPTION OF DRAWINGS

FIG. 1 is a diagram illustrating a display example of a function selection screen in an electronic device according to a first embodiment of the present disclosure;

FIG. 2 is a diagram illustrating a configuration of the electronic device;

FIG. 3 is a diagram illustrating a display example of a planning screen in the electronic device;

FIGS. 4A and 4B are diagrams illustrating a display example of an angle setting screen in the electronic device;

FIG. 5 is a flowchart illustrating an operation of a planning function in the electronic device;

FIG. 6 is a diagram illustrating a display example in setting a music playback range in the planning function;

FIG. 7 is a diagram illustrating a display example after angle setting in the electronic device;

FIG. 8A is a flowchart illustrating an angle setting processing in the electronic device;

FIG. 8B is a flowchart illustrating the angle setting processing subsequent to FIG. 8A;

FIG. 9 is a diagram illustrating a data structure of shooting angle data in the electronic device;

FIG. 10 is a diagram illustrating a display example of an angle selection screen in a shooting function of the electronic device;

FIG. 11 is a flowchart illustrating an operation of the shooting function in the electronic device;

FIG. 12 is a diagram illustrating a display example of a rating screen in the electronic device;

FIG. 13 is a flowchart illustrating of a recording mode processing in the electronic device;

FIGS. 14A to 14D are diagrams each illustrating a display example in the recording mode of the electronic device;

FIGS. 15A to 15C are diagrams for explaining a timer function in the recording mode of the electronic device;

FIGS. 16A and 16B are diagrams each illustrating a display example of a video edit screen in the electronic device;

FIG. 17A is a flowchart illustrating an operation of a video editing function in the electronic device;

FIG. 17B is a flowchart illustrating an operation of the video editing function subsequent to FIG. 17A;

FIGS. 18A and 18B are diagrams for explaining an operation of the video editing function in the electronic device; and

FIG. 19 is a flowchart illustrating the recording mode processing in a modification of the first embodiment.

### DETAILED DESCRIPTION

Embodiments will be described in detail below with reference to the drawings as appropriate. However, detailed description of already well-known matters and redundant description of substantially the same configuration may be omitted. Note that the accompanying drawings and the following description are provided for those skilled in the art to fully understand the present disclosure, and are not intended to limit the subject matter described in the claims.

### First Embodiment

In a first embodiment of the present disclosure, an electronic device having a video shooting function will be described.

### 1. Configuration

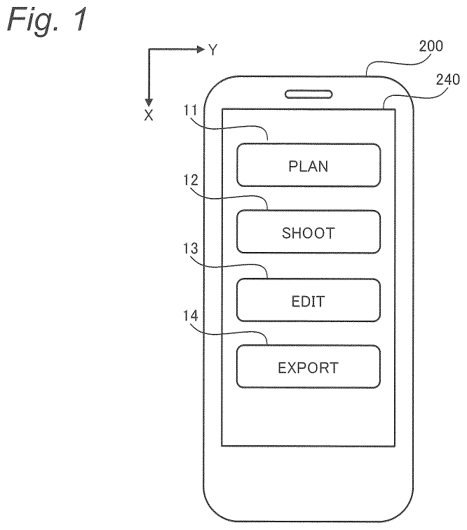

An electronic device 200 according to the first embodiment of the present disclosure will be described with reference to FIG. 1. The electronic device 200 of the present embodiment has various functions for sequentially providing information support to a user in production of a video work. FIG. 1 illustrates a display example of a function selection screen for selecting such various functions.

The electronic device 200 can be applied to a usage in which a user creates a desired video work such as a music video or a dance video by shooting and editing a plurality of videos in accordance with a music track, for example. The electronic device 200 provides information support useful for a series of workflow in which, for example, a user creates a plan indicating a concept of video shooting in accordance with the music track, repeats video shooting according to the created plan, and edits a plurality of shot videos. According to such information support, the workflow to create the video work can be easily managed, for example. The video data of the video work produced by the electronic device 200 can be exported to an external device via a communication network, for example.

### 1.1. Configuration of Electronic Device

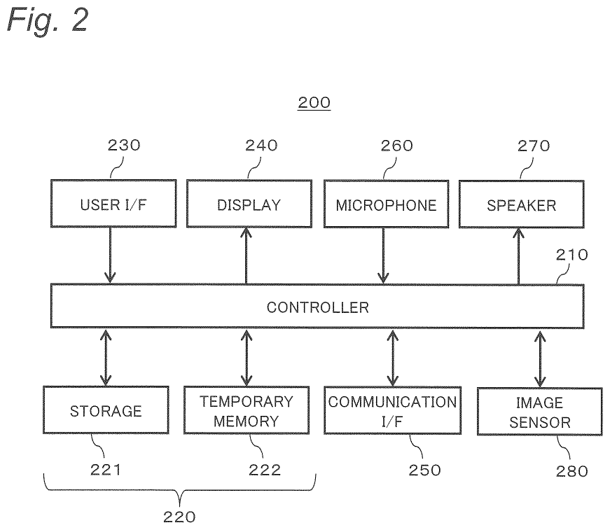

A configuration of the electronic device 200 according to the present embodiment will be described with reference to FIG. 2.

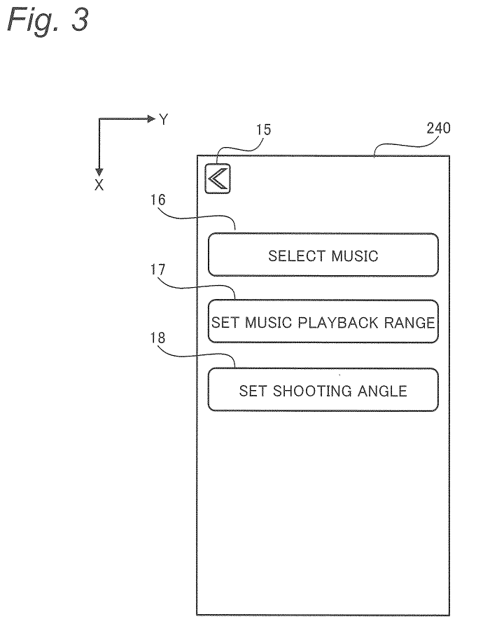

FIG. 3 is a diagram illustrating a configuration of the electronic device 200. The electronic device 200 includes, for example, a smartphone or a tablet terminal. The electronic device 200 illustrated in FIG. 3 includes a controller 210, a memory 220, a user interface 230, a display 240, a communication interface 250, a microphone 260, a speaker 270, and an imager 280.

The controller 210 includes a CPU or an MPU that realizes a predetermined function in cooperation with software, for example. The controller 210 controls the overall operation of the electronic device 200, for example. The controller 210 reads data and programs stored in the memory 220 and performs various calculation processing to realize various functions.

For example, the controller 210 executes a program including a command group for realizing each of the above-described functions. The above program may be provided from a communication network such as the Internet, or may be stored in a portable recording medium. The controller 210 may be a hardware circuit such as a dedicated electronic circuit or a reconfigurable electronic circuit designed to realize each of the above-described functions. The controller 210 may include various semiconductor integrated circuits such as a CPU, an MPU, a GPU, a GPGPU, a TPU, a microcomputer, a DSP, an FPGA, and an ASIC.

The memory 220 is a memory medium that stores programs and data for implementing the functions of the electronic device 200. As illustrated in FIG. 3, the memory 220 includes a storage 221 and a temporary memory 222.

The storage 221 stores parameters, data, control programs, and the like for realizing a predetermined function. The storage 221 includes an HDD or an SSD, for example. For example, the storage 221 stores the above-described programs, audio data indicating a music track, various image data, and the like.

The temporary memory 222 includes a RAM such as a DRAM or an SRAM, to temporarily store (i.e., hold) data, for example. For example, the temporary memory 222 holds image data being edited. In addition, the temporary memory 222 may function as a work area of the controller 210, and may be configured by a storage area in an internal memory of the controller 210.

The user interface 230 is a general term for operation members operated by a user. For example, the user interface 230 is a touch panel layered on the display 240 to input various touch operations, and is an example of an input interface of the electronic device 200. The input interface may be a connection software that is communicably connected to various external input devices and receives an operation signal. The user interface 230 may be a physical button, a switch, or the like provided in the electronic device 200, or a keyboard, a mouse, a touch pad, or the like may be used. The user interface 230 may be various GUIs such as virtual buttons and icons, cursors, software keyboards, and objects displayed on the display 240.

The display 240 includes a liquid crystal display or an organic EL display, for example. The display 240 may display various information such as various GUIs for operating the user interface 230 and information input from the user interface 230.

The communication interface 250 is a module (circuit) that connects to an external device according to a predetermined communication standard in wired or wireless communication. For example, the predetermined communication standard includes USB, HDMI (registered trademark), IEEE 802.11, Wi-Fi (registered trademark), Bluetooth (registered trademark), and the like. The communication interface 250 may connect the electronic device 200 to a communication network such as the Internet. The communication interface 250 is an example of an input interface that receives various information from an external device or a communication network.

The microphone 260 includes one or more microphone elements incorporated in the electronic device 200, for example. The microphone 260 outputs a sound signal indicating the collected sound to the controller 210. The electronic device 200 may include a connector such as a terminal connected to an external microphone instead of or in addition to the built-in microphone 260.

The speaker 270 includes one or more speaker elements built in the electronic device 200, and outputs a sound to the outside of the electronic device 200 under the control of the controller 210, for example. The electronic device 200 may include a connector connected to an external speaker, an earphone, or the like instead of or in addition to the built-in speaker 270. The speaker 270 and/or the connector are an example of an output interface in the present embodiment.

The imager 280 is realized by, for example, an optical system, an image sensor, and the like. The optical system includes various lenses, a diaphragm, a shutter, and the like. The image sensor is, for example, a CCD image sensor, a CMOS image sensor, or the like, and captures a subject image formed via the optical system to generate imaging data. The imaging data constitutes image data indicating an image captured by the image sensor. The image sensor generates image data of a new frame at a predetermined frame rate (e.g., 30 frames/second). The generation timing of the imaging data and an electronic shutter operation in the image sensor of the imager 280 are controlled by the controller 210. The lens in the optical system of the imager 280 may include a focus lens, and/or a zoom lens, and the like.

In the electronic device 200 of the present embodiment, the imager 280 includes, for example, a front camera provided on a surface having the display 240 and a rear camera provided on a surface facing the surface with the display 240. Furthermore, in the electronic device 200, the controller 210 may perform various types of processing on the imaging data output from the image sensor of the imager 280 to generate image data, or may perform various types of processing on the image data to generate an image to be displayed on the display 240.

The configuration of the electronic device 200 as described above is an example, and the configuration of the electronic device 200 is not limited thereto. For example, various display devices such as a projector and a head mounted display may be used as the display 240 of the electronic device 200. Furthermore, for example, in a case where an external display device is used, the display 240 of the electronic device 200 may be, for example, an output interface circuit of a video signal or the like conforming to the HDMI standard or the like.

### 2. Operation

The operation of the electronic device 200 configured as described above will be described below.

The electronic device 200 of the present embodiment provides various functions in a workflow of video production, for example, as illustrated in FIG. 1.

The display 240 of the electronic device 200 displays a planning button 11, a shooting button 12, a video editing button 13, and an export button 14 on the function selection screen illustrated in FIG. 1. Hereinafter, the longitudinal direction on the screen of the display 240 is defined as an X direction, and the width direction is defined as a Y direction.

The planning button 11 is a virtual button that receives a user operation to execute a planning function in the electronic device 200. The planning function is a function of performing information support for a process of creating a plan by the user before video shooting. The electronic device 200 of the present embodiment manages various information on each shooting angle at which video shooting is performed in the created plan. The shooting angle constitutes a shooting unit such as a unit that manages video shooting for a time range in the music track, for example.

For example, the shooting button 12 is a virtual button for executing a function (i.e., a shooting function) of supporting video shooting of each shooting angle in a plan created by the planning function. The number of times of shooting a video for one shooting angle is not particularly limited to one take, and may be a plurality of takes. In the present embodiment, the electronic device 200 controls video shooting by the electronic device 200 in the shooting function, and manages a shooting result for each shooting angle.

The video editing button 13 is a virtual button for executing a function (i.e., a video editing function) of supporting the process of editing the video data of the shooting result for each shooting angle by the shooting function. The video editing function provides information support for facilitating a process of editing video data of multiple shooting results shot according to the plan to create the video work, for example.

The export button 14 is a virtual button for executing a function (i.e., an export function) of outputting a video of an editing result by the video editing function. In the export function, the electronic device 200 receives a user operation for designating, for example, an output destination and an output format of the video. For example, the output format can be selected from options of one video file and multiple files, the one video file indicating the video work in which video data of the multiple shooting results are integrated by the video editing function, the multiple files being an output format that can be easily edited in an external video editing software.

The electronic device 200 according to the present embodiment can provide comprehensive information support from planning to exporting after video editing when the user sequentially uses the functions of the planning button 11, the shooting button 12, the video editing button 13, and the export button 14.

The function selection screen of the electronic device 200 may further include a delete button for deleting various data in the information support as described above. For example, the electronic device 200 may collectively delete the video files of the shooting results according to the same plan in response to the user operation of the delete button.

### 2.1. Planning Function

The outline of the operation of the planning function in the electronic device 200 will be described with reference to FIGS. 1, 3, 4A and 4B.

When a user operation such as tapping the planning button 11 on the function selection screen of FIG. 1 is input from the user interface 230, the controller 210 of the electronic device 200 causes the display 240 to display a planning screen as illustrated in FIG. 3. The planning screen is a screen for selecting each function in the planning function. The display 240 displays a return button 15, a music selection button 16, a range setting button 17, and an angle setting button 18 on the planning screen illustrated in FIG. 3.

The return button 15 receives a user operation to return the screen transition in the electronic device 200 by one screen. For example, the controller 210 displays the function selection screen (FIG. 1) on the display 240 in response to a user operation of the return button 15 on the planning screen (FIG. 3).

The music selection button 16 is a virtual button for executing a function of selecting a music track to be played back in the video work. The range setting button 17 is a virtual button for executing a function of designating a music playback range in the video work from a time length of the music track selected by the music selection function, the music playback range corresponding to a video playback period in which the music track is played back in the video work. The angle setting button 18 is a virtual button for executing a function of setting the shooting angle in video shooting in association with audio data of the music track.

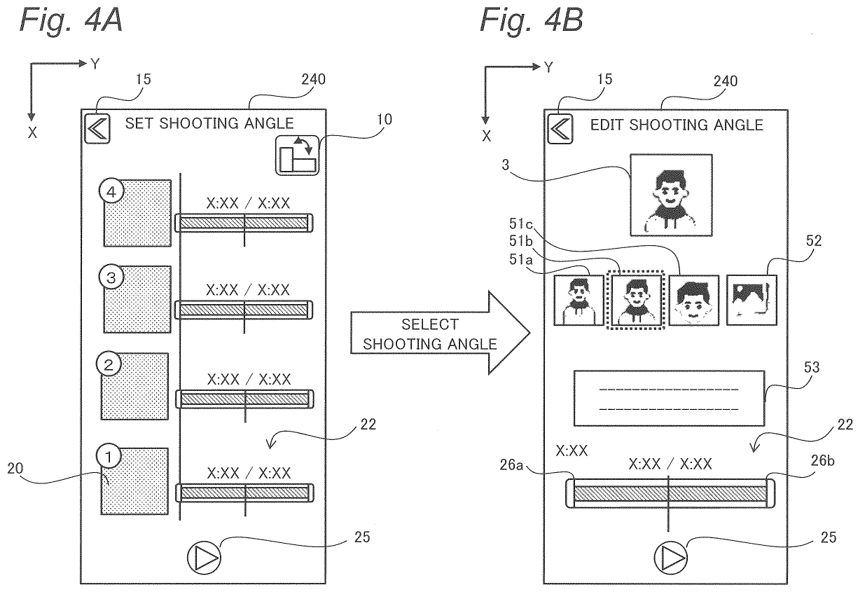

For example, when the angle setting button 18 is selected on the planning screen, the controller 210 displays an angle setting screen illustrated in FIG. 4A on the display 240, and receives various user operations related to angle setting via the user interface 230.

For example, the controller 210 displays an angle edit screen illustrated in FIG. 4B on the display 240 in response to a user operation of selecting an angle setting field 20 for each shooting angle on the angle setting screen. In the electronic device 200, the angle setting field 20 receives a user operation selecting an angle to be set. The angle edit screen is a screen for editing the angle of the selected shooting angle setting field 20. In the present embodiment, as illustrated in FIG. 4A, an example in which up to four shooting angles can be set in a plan in creation of one video work will be described.

### 2.1.1. Overall Operation of Planning Function

The overall operation of the planning function in the electronic device 200 will be described with reference to FIGS. 3 to 7.

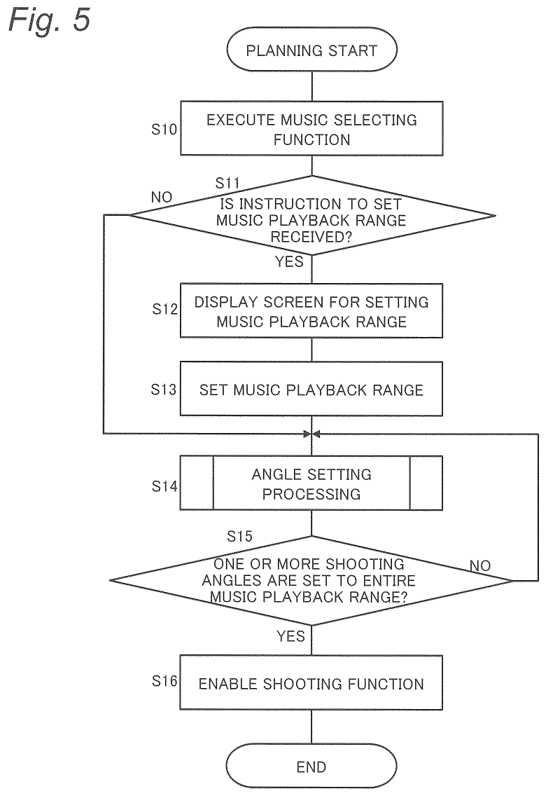

FIG. 5 is a flowchart illustrating an operation of the planning function in the electronic device 200. Each processing illustrated in the flowchart of FIG. 5 is executed by, for example, the controller 210 of the electronic device 200. For example, the processing of this flowchart is started when the planning button 11 on the function selection screen (FIG. 1) is operated in a state where the planning screen (FIG. 3) is displayed on the display 240.

For example, the controller 210 executes the function of music selection in response to a user operation selecting, by tapping or the like, the music selection button 16 on the planning screen (S10). For example, the controller 210 causes the display 240 to display titles of music tracks each indicated by audio data as options based on the audio data stored in the storage 221 or the like, the metadata associated with the audio data, and the like. When a user operation selecting an option of a music track displayed is input via the user interface 230, the controller 210 reads the audio data of the selected music track to the temporary memory 222, and causes the display 240 to transit to the planning screen, for example. The controller 210 may store information indicating the selected music track in the memory 220 in association with shooting angle data, which is described later.

Next, the controller 210 determines whether or not an instruction for setting the music playback range is received, for example, based on whether or not a user operation to select the range setting button 17 on the planning screen is input via the user interface 230 (S11). For example, after selecting the music track in step S10, the controller 210 may enable the range setting button 17 and the angle setting button 18 to be in a selectable state on the planning screen.

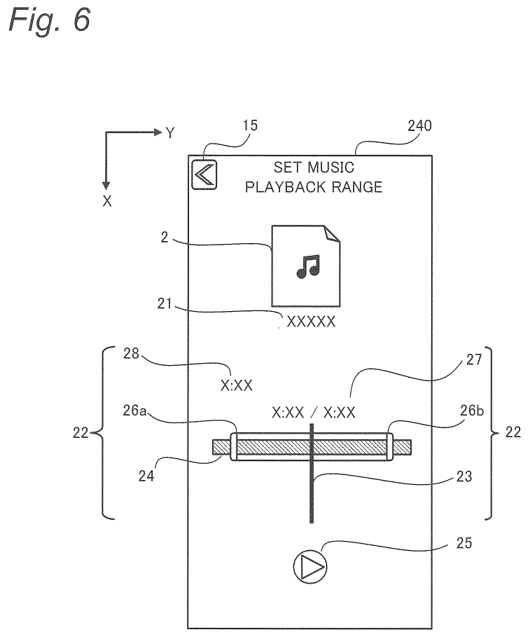

When an instruction for setting the music playback range is received (YES in S11), the controller 210 causes the display 240 to display a screen for the user to designate a time range within the music track by a function to set the music playback range (S12). FIG. 6 illustrates a display example of a setting screen of the music playback range. The setting screen illustrated in FIG. 6 includes a music icon 2, a music name 21 indicating a title, a file name, or the like of the music track, a playback field 22, a playback button 25, and the return button 15. The controller 210 receives various user operations related to the displayed setting screen for the music playback range via the user interface 230. For example, sound output by the speaker 270 or the like is started or stopped by a user operation of the playback button 25.

In the electronic device 200, the playback field 22 receives a user operation designating a time range associated with a video from a period for which the music track is played back in the audio data. As illustrated in FIG. 6, for example, the playback field 22 includes a playback head 23, a sound timeline 24, markers 26a and 26b, a period display 27, and a marker time 28.

The playback head 23 is arranged on the sound timeline 24, for example, and indicates a position corresponding to a time in playing the music track of the audio data indicated by the music name 21. The sound timeline 24 is sequentially updated according to playing the music track with displaying, from a position indicated by the playback head 23 in the period of the audio data, a time range already played in the −Y direction and a time range to be played in the +Y direction, for example. The sound timeline 24 may display a part of the period, such as a predetermined period around (i.e., before and after) the position of the playback head 23 in the audio data. For example, the predetermined period displayed in the sound timeline 24 may be changed by a user operation such as pinching in and pinching out on the sound timeline 24. Furthermore, the playback head 23 may be fixed to the center in the Y direction in the sound timeline 24, and for example, a time corresponding to the playback head 23 may be changed by a user operation of scrolling the sound timeline 24 in the +Y direction or −Y direction.

The marker 26a and the marker 26b indicate a start point and an end point of the time range designated from the period of the audio data, respectively, and move in the Y direction on the sound timeline 24 according to a drag operation or the like. The period display 27 indicates one or more time ranges within the music track in the audio data. In the screen of FIG. 6, the period display 27 displays the time range from the start point to the end point designated by the marker 26 with the entire period set in the setting of the music playback range. The marker time 28 indicates a time in which the marker 26a or the marker 26b being operated is located in the audio data.

Referring back to FIG. 5, when the return button 15 is operated, for example, after the user operation designating a range in the period of the music track is input from the user interface 230 by the markers 26a and 26b, the controller 210 sets the designated range as the music playback range to be played back in the video work (S13). The controller 210 may store information indicating the music playback range set in association with the audio data of the music track in the memory 220 or the like.

On the other hand, when no instruction to set the music playback range is input (NO in S11), the controller 210 proceeds to the processing of step S14. In this case, for example, the entire period of the music track in the audio data is set as the music playback range to be played back in the video work.

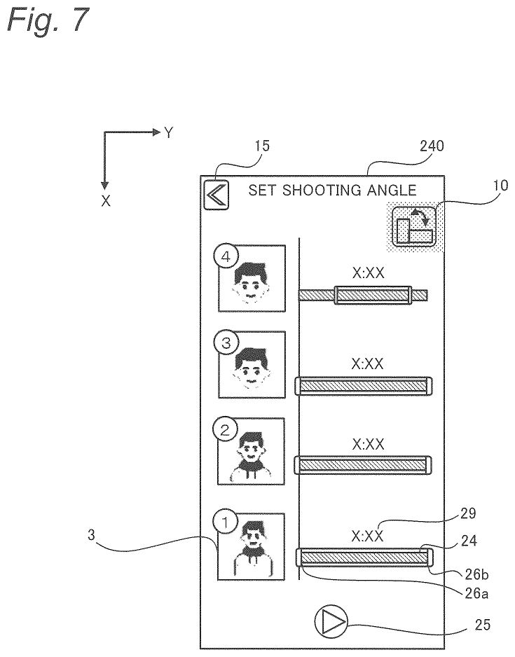

The controller 210 executes a function to set shooting angles in response to a user operation selecting the angle setting button 18 on the planning screen (FIG. 3), for example (S14). For example, the controller 210 generates shooting angle data including setting information on the shooting angles, the setting information being input in accordance with various user operations on the angle setting screen (FIG. 4A) and the angle edit screen FIG. 4B) (S14). In the electronic device 200 according to the present embodiment, the shooting angle data is an example of management information managing a video shot in association with the audio data of the music track. FIG. 7 illustrates the angle setting screen after such angle setting processing (S14) is completed.

FIG. 7 illustrates an example in which four shooting angles are set. For example, the controller 210 assigns an angle number in ascending order for each shooting angle arranged and sequentially set in the X direction on the angle setting screen. The angle number indicating information identifying each shooting angle in the shooting angle data.

In the electronic device 200 according to the present embodiment, the shooting angle is an example of a shooting unit that manages how video shooting in accordance with the music track is performed in association with a time range specified by the user in the period of the music track indicated by the audio data. The electronic device 200 can manage a plurality of shot videos for the designated range in the music track for each shooting angle. A plurality of takes may be associated with each shooting angle.

For example, an angle icon 3 is set for each shooting angle, the angle icon 3 indicating a composition with respect to a subject in video shooting for each shooting angle. Furthermore, a designated period 29 for each shooting angle in the display example of FIG. 7 indicates a range designated for each shooting angle in the period of the music track, and corresponds to a range designated by the marker 26 on the sound timeline 24, which are provided similarly to the setting screen for the music playback range, for example (see, FIG. 6). As illustrated in FIG. 7, for example, the electronic device 200 according to the present embodiment can set multiple shooting angles to mutually overlapping ranges in the period of music track.

In the electronic device 200 according to the present embodiment, for example, by setting multiple shooting angles to an overlapping range of the music track and performing video shooting according to the set multiple shooting angles, a shooting result of a shooting angle desired by the user can be adopted to the video work by the video editing function, the shooting result being selected from shooting results of respective shooting angles. Details of the angle setting processing (S14) will be described later.

After the angle setting processing (S14) is performed, the controller 210 refers to generated shooting angle data and determines whether or not one or more shooting angles are set to the entire music playback range set in step S13, for example (S15). In a case where no instruction to set the music playback range is input (NO in S11), the determination in step S15 may be performed for the entire period of the music track in the audio data. In a case where one or more angles are not set to the entire music playback range (NO in S15), the controller 210 repeats the processing of step S14.

In a case where one or more angles are set to the entire music playback range (YES in S15), the controller 210 enables the shooting function in the electronic device 200 (S16), and ends the processing of this flowchart. For example, on the function selection screen (FIG. 1), the controller 210 may change a state for receiving a user operation of the shooting button 12 from an invalid state to a valid state.

According to the processing of the planning function described above, the music track to be played back in the video work is selected (S10), and one or more shooting angles are set in association with the audio data of the selected music track (S14, S15). According to each set shooting angle, video shooting in accordance with the music track can be easily managed in the subsequent shooting function, for example.

Furthermore, in the angle setting processing (S14) of the present embodiment, as illustrated in FIG. 7, multiple shooting angles can be set for each designated range in the period of music track, the multiple shooting angles each including the composition for video shooting and the like. Therefore, according to the set multiple shooting angles, it is possible to easily perform video shooting in different compositions or the like for time ranges overlapping with each other in the music track, for example.

### 2.1.2. Angle Setting Processing

Details of the angle setting processing in step S14 in FIG. 5 will be described with reference to FIGS. 4A, 4B and 7 to 9.

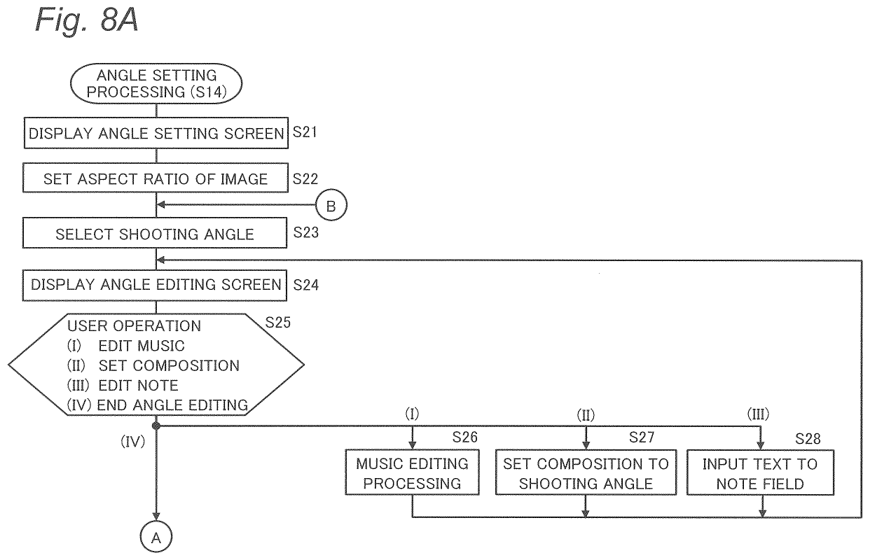

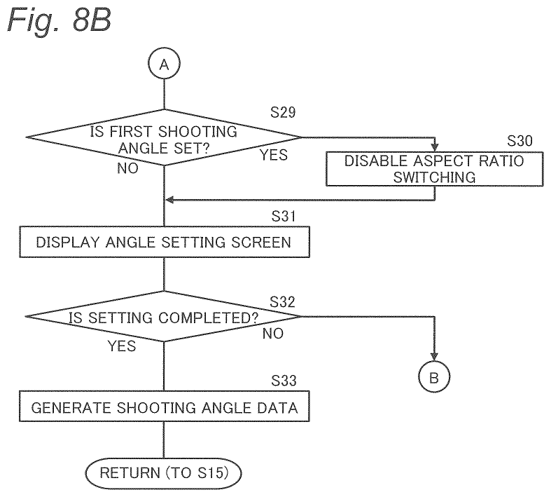

FIG. 8A is a flowchart illustrating the angle setting processing (S14) in the electronic device 200. FIG. 8B is a flowchart illustrating the angle setting processing (S14) subsequent to FIG. 8A. The processing illustrated in the flowchart is started in a state where the audio data of the music track is read to the temporary memory 222, for example, after the music track is selected (S10 in FIG. 5) or after the music playback range is set by the user operation (S13).

First, the controller 210 of the electronic device 200 causes the display 240 to display the angle setting screen illustrated in FIG. 4A (S21). For example, the angle setting screen includes the playback button 25, the return button 15, and an aspect ratio switching button 10 in addition to the angle setting field 20 and the playback field 22 for each shooting angle. The aspect ratio switching button 10 is a virtual button that receives a user operation for collectively switching aspect ratios of images in the video shooting for respective shooting angles.

The controller 210 receives, via the user interface 230, a user operation of tapping the aspect ratio switching button 10 on the angle setting screen, and sets the aspect ratios of images recorded in the video shooting (S22). In the electronic device 200 of the present embodiment, a common aspect ratio is set for all shooting angles.

The controller 210 receives a user operation such as tapping the angle setting field 20 for each shooting angle, via the user interface 230, and selects one angle corresponding to the tapped angle setting field 20 (S23).

The controller 210 causes the display 240 to display an angle edit screen for the selected shooting angle (S24). As illustrated in FIG. 4B, for example, the angle edit screen includes the angle icon 3, preset icons 51a, 51b, and 51c, an input icon 52, a note field 53, the playback field 22, the playback button 25, and the return button 15.

The preset icons 51 and the input icon 52 are displayed as options of the angle icon 3. In the electronic device 200 of the present embodiment, the preset icons 51 re registered in advance as templates of the composition such as a zoom magnification or an angle of view in video shooting, for example. For example, the preset icons 51a, 51b, and 51c respectively indicate compositions such as wide, medium, and tight in ascending order of zoom magnification.

The input icon 52 receives a user input for setting the composition different from preset icons 51 to the shooting angle in electronic device 200. For example, when the input icon 52 is selected by the user operation, the controller 210 may receive a user input for drawing an icon by executing a drawing function or the like of the electronic device 200. The note field 53 receives input of various types of information, such as a shooting place and/or a shooting direction with respect to the subject by text input, the information being input as desired information by the user in the video shooting for the selected shooting angle.

For example, as illustrated in FIG. 4B, the controller 210 receives various user operations via the user interface 230 such as the touch panel in a state where the display 240 displays the angle edit screen (S25). The user operations in step S25 includes (I) a music editing operation, (II) a composition setting operation, (III) a note editing operation, and (IV) an exit operation. For example, the controller 210 stores information input by each user operation in the temporary memory 222 or the like in association with the angle number of the selected shooting angle.

The music editing operation ((I) in S25) is a user operation for playing back or stopping the music by tapping the playback button 25 on the angle edit screen, or a user operation changing the time range for the selected shooting angle by dragging the marker 26 in the playback field 22, for example. For example, in an initial state where the processing of this flowchart is started, the time range for each shooting angle may be the entire music playback range or a range set from the entire range by the user operation in step S13 in FIG. 5.

When the music editing operation is input ((I) in S25), the controller 210 causes the speaker 270 to output a sound based on the audio data to play the music track, and stores a time indicating the changed time range in the temporary memory 222 in association with the selected shooting angle (S26). After the music editing processing (S26) is performed, the controller 210 repeats the processing in and after step S24. In this way, for example, the displayed playback field 22 is updated according to the playback of the music track and the change of the time range.

The composition setting operation ((II) in S25) is a user operation for setting the angle icon 3 corresponding to the composition in video shooting for the selected shooting angle, and is a tap operation of the preset icons 51 or the input icon 52 on the angle edit screen, for example.

When the composition setting operation is input ((II) in S25), the controller 210 changes the angle icon 3 according to the composition setting operation input by the user, associates the angle icon 3 with the selected shooting angle as the set composition, and stores the angle icon 3 in the temporary memory 222 or the like (S27). Thereafter, the processing in and after step S24 is repeated, and the angle edit screen is updated. In the example of FIG. 4B, the preset icon 51b is selected as the angle icon 3.

The note editing operation ((III) in S25) is a user operation for inputting a text into the note field 53, and is a tap operation of the note field 53, for example. When a note editing operation is input ((III) in S25), the controller 210 receives a text input into the note field 53 by a software keyboard or the like in the user interface 230, and updates the note field 53 in the display 240, for example (S28). Thereafter, the controller 210 repeats the processing in and after step S24.

The exit operation ((IV) in S25) is a user operation for ending the editing of the selected shooting angle, and is a user operation of the return button 15 in the angle edit screen, for example (FIG. 4B). When the exit operation is input ((IV) in S25), the controller 210 refers to the temporary memory 222, and determines whether or not the first shooting angle, that is, the angle of the angle number “1” is set, for example (S29 in FIG. 8B).

When the first shooting angle is set (YES in S29), the controller 210 invalidates the user operation of the aspect ratio switching button 10 on the angle setting screen, for example (S30). For example, as illustrated in the angle setting screen of FIG. 7, the aspect ratio switching button 10 may be grayed out. As described above, in the electronic device 200 according to the present embodiment, the aspect ratio of images can be set only when the first shooting angle is set (S22 in FIG. 8A). In this way, for example, it is possible to avoid a situation in which different aspect ratios are set among a plurality of shooting angles, and to facilitate management of video shooting in the plurality of angles.

After the execution of step S30, the controller 210 causes the display 240 to display the angle setting screen again (S31). On the other hand, when the first shooting angle is not set (NO in S29), the controller 210 proceeds to displaying the angle setting screen (S31) without performing the processing of step S30.

The controller 210 determines whether or not the angle setting is completed according to the user operation on the angle setting screen, for example (S32). For example, in a case where the user operation of the return button 15 on the angle setting screen is not input via the user interface 230, the controller 210 determines that the angle setting is not completed (NO in S32), and repeats the processing in and after step S23. As a result, setting on the angle edit screen can be performed for each shooting angle selected on the angle setting screen.

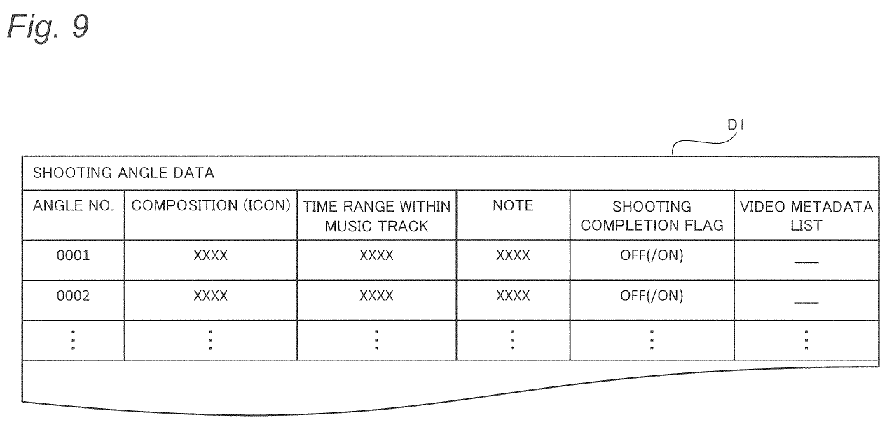

On the other hand, when it is determined that the angle setting is completed, for example, when the user operation of the return button 15 is input on the angle setting screen (YES in S32), the controller 210 generates the shooting angle data including the setting information input by various user operations in step S25 (S33). The shooting angle data is stored in the memory 220, for example. The shooting angle data at the end of such angle setting processing is illustrated in FIG. 9.

FIG. 9 is a diagram illustrating a data structure of shooting angle data D1 in the electronic device 200. For example, as illustrated in FIG. 9, the shooting angle data D1 manages information on items of “composition”, “time range within music track”, “note”, “shooting completion flag”, and “video metadata list” in association with each other for each “angle number”.

For each shooting angle of each angle number, the controller 210 records the composition indicated by the angle icon 3 on the angle edit screen, the time range designated in the playback field 22, and the information input in the note field 53, respectively in the “composition”, the “time range”, and the “note” of the shooting angle data D1.

In the shooting angle data D1, the “shooting completion flag” manages whether the shooting angle is in a shooting completion state or in a shooting incompletion state by ON/OFF, the shooting completion state indicating that video shooting is completed, the shooting incompletion state indicating that video shooting is not completed. At the end of the angle setting processing, the shooting completion flag is set to OFF for each of all shooting angles as an initial setting.

The “video metadata list” is a list for storing metadata of a video shot in the shooting angle. At the end of the angle setting processing, an empty value is set to the video metadata list as an initial setting.

After generating the shooting angle data D1 (S33), the controller 210 changes the screen on the display 240 from the angle setting screen to the planning screen (FIG. 3), and ends the processing of this flowchart, for example.

According to the angle setting processing (S14) described above, in the planning function, the shooting angle data D1 including the time range within the music track, the composition of video shooting, and the like for each shooting angle is generated based on the user input on the angle setting screen and the angle edit screen. In this way, in the plan for producing the video work in accordance with the music track, the shooting angle in video shooting for the time range within the music track can be set.

The angle setting processing of the electronic device 200 is not limited to the above example. For example, the controller 210 may receive the user operation of music editing ((I) in S25) on the angle setting screen to perform the music editing processing (S26) without being limited to receiving the user operation on the angle edit screen.

### 2.2. Shooting Function

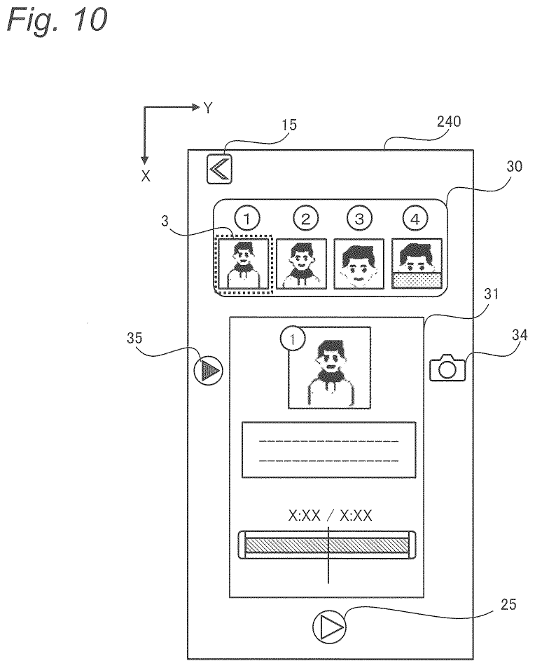

An outline of an operation of the shooting function in the electronic device 200 will be described with reference to FIG. 10.

FIG. 10 illustrates a display example of an angle selection screen in the electronic device 200. The angle selection screen is provided in the shooting function of the electronic device 200, and is a screen for selecting a shooting angle desired by the user from shooting angles set by the planning function, for example.

For example, as illustrated in FIG. 10, the angle selection screen includes an angle list 30, an angle display field 31, a recording mode button 34, a playback mode button 35, the playback button 25, and the return button 15. The angle list 30 is a list listing various shooting angles as options selectable by the user. The angle display field 31 is a display field that displays setting information on the selected shooting angle. Details of the angle selection screen will be described later.

In the shooting function, the electronic device 200 provides information support that makes it easy for the user to comprehensively carry out video shooting of each shooting angle with checking respective shooting angles, by using the angle selection screen illustrated in FIG. 10, for example. The user may perform video shooting in an order different from the order of the angle numbers in the plan, or may perform video shooting of a plurality of takes for one angle.

Therefore, the electronic device 200 receives rating by the user of the video for the selected shooting angle at shooting the video of each take, manages whether or not the shooting of the shooting angle is completed, and visualizes the progress status of the video shooting for each shooting angle to the user in the angle list 30. Hereinafter, details of the operation of the shooting function in the electronic device 200 will be described.

### 2.2.1. Overall Operation of Shooting Function

The overall operation of the shooting function in the electronic device 200 will be described with reference to FIGS. 10 to 12.

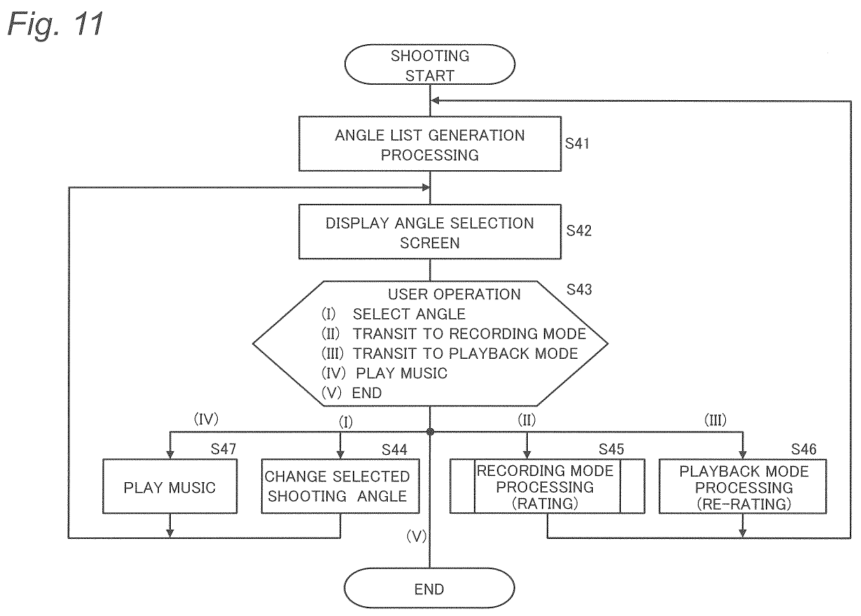

FIG. 11 is a flowchart illustrating an operation of the shooting function in the electronic device 200. Each processing illustrated in the flowchart of FIG. 11 is executed by the controller 210, for example. The processing of this flowchart is started, for example, when the shooting button 12 on the function selection screen (FIG. 1) is operated in a state where the shooting angle data D1 set by the planning function is stored in the memory 220.

First, the controller 210 generates the angle list 30 to be displayed on the angle selection screen (FIG. 10) based on the shooting angle data D1 (S41). The angle list 30 of the present embodiment is generated to list shooting angles in the plan and to identify and display whether or not each shooting angle is in the shooting completion state. For example, the controller 210 determines whether or not the shooting completion flag of the angle in the shooting angle data D1 is ON for each shooting angle, and sets the corresponding angle icon 3 to the shooting completion state in a case where the shooting completion flag is ON. On the other hand, when the shooting completion flag of the angle is not ON but OFF, the controller 210 sets the corresponding angle icon 3 to the shooting incompletion state.

In the electronic device 200, such angle list generation processing (S41) is repeatedly executed in accordance with, the progress of video shooting and various operations by the user during execution of the image shooting function, and sequentially updates the angle list 30, for example.

Next, the controller 210 causes the display 240 to display an angle selection screen based on the generated angle list 30 and the shooting angle data D1, as illustrated in FIG. 10, for example (S42).

The angle list 30 on the angle selection screen includes a plurality of angle icons 3 as illustrated in FIG. 10, for example. Each angle icon 3 indicates an individual shooting angle of the angle list 30 as an option. The selected angle icon 3 is set to the angle number “1” in the initial state, for example.

For example, the controller 210 controls the display 240 to highlight the angle icon 3 indicating the selected shooting angle (S42). For example, the highlighting of the selected angle icon 3 is a larger display size than that of the other angle icons 3, a frame enclosure of a highlight color, and the like. Further, the controller 210 refers to the shooting angle data D1 to display, in the angle display field 31, setting information on the shooting angle indicated by the selected angle icon 3 (S42).

In the example of FIG. 10, the angles with the angle numbers “1” to “3” are in the shooting incompletion state, and the angle with the angle number “4” is in the shooting completion state. In the angle list 30, the angle icon 3 has a display attribute for identifying the shooting completion state and the shooting incompletion state. Such a display attribute is set, for example, to add a highlight to a display mode of the shooting completion state in comparison with a display mode of the shooting incompletion state.

For example, as illustrated in FIG. 10, in a state where the display 240 displays the angle selection screen, the controller 210 receives various user operations via the user interface 230 such as the touch panel (S43). The user operations in step S43 includes (I) an angle selection operation, (II) a transition operation to the recording mode, (III) a transition operation to playback mode, (IV) a music playback operation, and (V) an exit operation.

The angle selection operation ((I) in S43) is a user operation for changing the selected shooting angle, and is a user operation of tapping the angle icon 3 other than the selected angle icon 3 in the angle list 30 displayed on the angle selection screen, for example. The angle selection operation is not limited thereto, and for example, a swipe operation in the angle display field 31 may be input as the angle selection operation for changing the selected shooting angle to an adjacent angle.

When the angle selection operation is input ((I) in S43), the controller 210 changes the selected angle icon 3 according to the input angle selection operation (S44), and performs the processing in and after step S42 again. As a result, on the angle selection screen, the selected angle icon 3 is changed, and the angle display field 31 is displayed for the new selected shooting angle (S42).

The transition operation to the recording mode ((II) in S43) is a user operation for changing an operation mode to a recording mode which is an operation mode for performing video shooting with respect to the selected shooting angle, and the transition operation is a tap operation of the recording mode button 34, for example. Additionally or alternatively, the transition operation may be a swipe operation in a predetermined one of the +Y direction and −Y direction of the angle selection screen. Furthermore, the recording mode button 34 may be omitted.

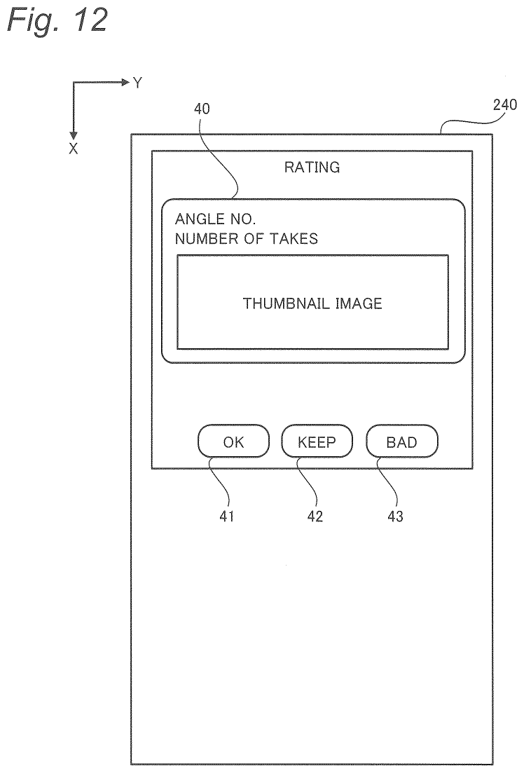

When the transition operation to the recording mode is input ((II) in S43), the controller 210 executes, as the recording mode, various types of processing for video shooting of one take performed in association with the selected shooting angle (S45). For example, in the video shooting, the controller 210 performs the sound output to play the music track for the time range associated with the selected shooting angle. In addition, the controller 210 executes processing related to rating of a shot take. A display example in step S45 is illustrated in FIG. 12.

FIG. 12 illustrates a display example of a rating screen in the electronic device 200. The rating screen is a screen for prompting the user to perform a rating for determining the rating of the video of the shot take.

As illustrated in FIG. 12, the rating screen includes an information display field 40 for a shot video, an OK button 41, a KEEP button 42, and an BAD button 43 as rating options, for example. The information display field 40 displays information related to the video of the shot take, and includes a thumbnail image of the video of the take, an angle number associated with the take, and the number of takes, for example.

The OK button 41 indicates a rating “OK” indicating that the user determined to adopt the take for the corresponding shooting angle, for example. The KEEP button 42 indicates a rating “KEEP” on which it is difficult for the user to determine whether or not to adopt the take, for example. The BAD button 43 indicates a rating “BAD” (i.e., No Good) in which the user determined that it is clear that the take is not adopted, for example. The controller 210 manages the shooting completion flag in the shooting angle data D1 based on such information indicating the rating. For example, the shooting completion flag is turned on in a case where a video having a rating of “OK” or “KEEP” is included in videos associated with the selected shooting angle, and the shooting completion flag is turned off otherwise.

In the processing in the recording mode according to the present embodiment (S45), every time video shooting of one take is performed, for example, the rating screen in FIG. 12 is displayed to acquire rating information indicating a user rating of the take. Based on the rating result of such recording mode processing (S45), the controller 210 performs the angle list generation processing (S41) again as illustrated in FIG. 11 and updates the angle list 30. Details of the processing of step S45 will be described later.

The transition operation to the playback mode ((III) in S43) is a user operation for changing an operation mode to the playback mode, and is a user operation of the playback mode button 35, for example. The playback mode is an operation mode for playing back and displaying the video shot with respect to the selected shooting angle. Additionally or alternatively, the transition operation to the playback mode may be a swipe operation in a direction opposite to the transition operation to the recording mode among the +Y direction and −Y direction of the angle selection screen. Furthermore, the playback mode button 35 may be omitted.

When the transition operation to the playback mode is input ((III) in S43), the controller 210 executes processing of playing back videos of various takes related to the shooting angle being selected for the playback mode (S46). In a processing of the playback mode in the present embodiment (S46), re-rating for changing the rating on the video of each take can be executed. Based on the re-rating result of the processing of the playback mode (S46), the controller 210 performs the angle list generation processing (S41) again and updates the angle list 30.

The music playback operation ((IV) in S43) is a user operation for playing the music track for the time range associated with the selected shooting angle, and is a user operation of the playback button 25, for example. When the music playback operation is input ((IV) in S43), the controller 210 causes the speaker 270 or the like to output the sound for the time range of the shooting angle based on the audio data of the music track (S47), and performs the processing in and after step S42 again. In this way, for example, the user can easily confirm the time range associated with the selected shooting angle, and can easily perform the video shooting for each shooting angle.

The exit operation ((V) in S43) is a user operation for ending the shooting function, and is, for example, a user operation of the return button 15 on the angle selection screen (FIG. 10). When the exit operation is input ((V) in S43), the controller 210 changes the screen on the display 240 from the angle selection screen to the function selection screen (FIG. 1), for example, and ends the processing shown in this flowchart.

According to the above processing, the user of the electronic device 200 can shoot a video for a desired shooting angle (S45) or perform the user operation of playback and display for the shooting angle (S46) with checking various shooting angles on the angle selection screen (FIG. 10) in the shooting function of the electronic device 200 (S44). In this way, the user can easily manage the video shooting in the multiple shooting angles set in the plan.

On the angle selection screen of the present embodiment, each shooting angle icon 3 is identified and displayed depending on whether or not the shooting is completed, therefore it is possible to suppress a situation in which a shooting angle is forgotten by the user forgets to shoot. By performing the identification display of whether or not the shooting is completed for each shooting angle to reflect the rating of the video of each take by the user, it can be facilitated to ensure the video quality according to the intention of the user. Such rating is performed every time a take is shot (S45), and re-rating can be performed in the playback mode (S46). Therefore, it is possible to easily realize quality management of video shooting according to the user's intention.

The angle selection screen displayed in step S42 is not limited to the example of FIG. 10, and may be displayed, for example, according to the maximum number of shooting angles that can be set in the plan. For example, in a case where the number of angles set in the shooting angle data D1 is less than four, an unset shooting angle not included in the angle list 30 may be grayed out to indicate that the shooting angle is not selectable in the angle selection screen.

### 2.2.2. Recording Mode Processing

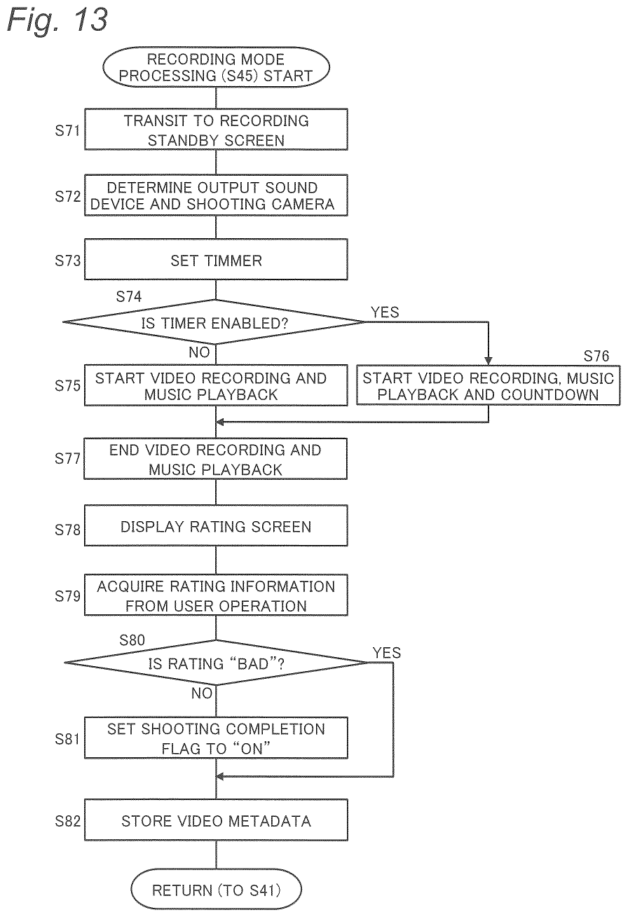

Details of the recording mode processing in step S45 of FIG. 11 will be described with reference to FIGS. 13, 14A to 14D and 15A to 15C.

FIG. 13 is a flowchart illustrating the recording mode processing (S45) in electronic device 200 of the present embodiment. The processing illustrated in the flowchart of FIG. 13 is started, for example, when the transition operation to the recording mode is input on the angle selection screen (FIG. 10) ((II) of S43).

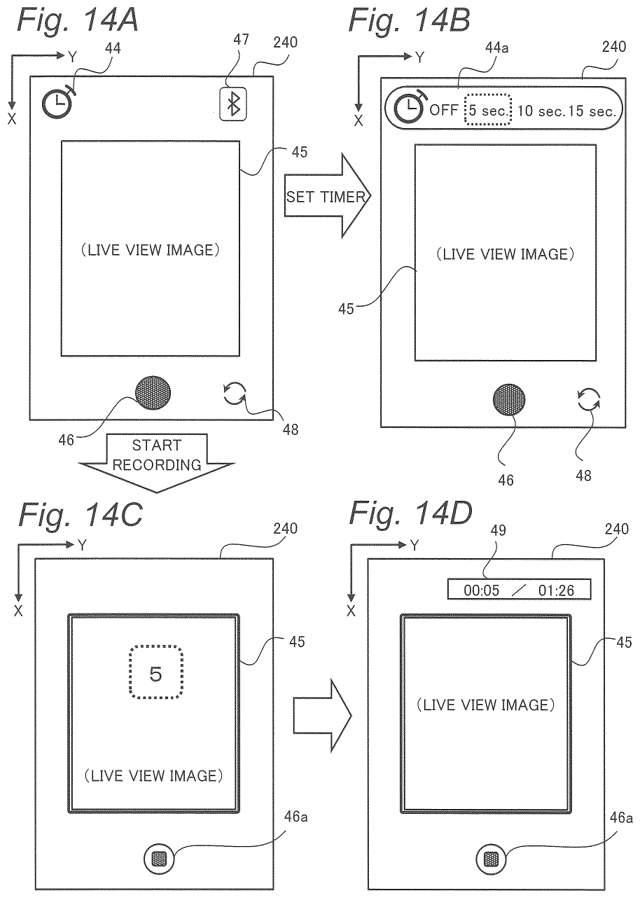

First, the controller 210 changes the operation mode to the recording mode and causes the display 240 to display a recording standby screen for waiting for video shooting (S71). A display example of the electronic device 200 in step S71 is illustrated in FIG. 14A.

As illustrated in FIG. 14A, for example, the recording standby screen in step S71 includes a timer button 44, a live view image 45, a recording button 46, a speaker icon 47, and a camera switching button 48. For example, in the recording mode, the controller 210 sequentially acquires the image data of the live view image 45 from the imager 280 and displays the live view image 45.

The timer button 44 receives, for example, a user operation for setting a timer period to adjust timing at the start of video shooting. The recording button 46 receives a user operation for starting shooting and recording of a video. The speaker icon 47 displays, for example, a connection state with an external speaker via the communication interface 250. In the shooting function of the present embodiment, the communication connection with the external speaker may be managed, and for example, at the time of transition to the recording mode, display prompting connection with the external speaker may be performed. The camera switching button 48 receives a user operation for switching between the front camera and the rear camera of the imager 280 in video shooting.

The controller 210 determines an output sound device and a shooting camera in video shooting (S72). The output sound device indicates a speaker that outputs a sound, and is determined according to, for example, a connection state with the external speaker indicated by the speaker icon 47. For example, when the electronic device 200 is connected to the external speaker, the controller 210 determines the external speaker as the output sound device, and when the electronic device is not connected to the external speaker, the controller determines the speaker 270 as the output sound device. The shooting camera indicates a camera that performs video shooting, and is, for example, the front camera or the rear camera of the imager 280. The controller 210 determines a shooting camera according to a user operation such as tapping of the camera switching button 48 on the recording standby screen, for example.

The controller 210 sets a timer period in accordance with a user operation of the timer button 44, for example (S73). A display example of the electronic device 200 in step S73 is illustrated in FIG. 14B. The setting of the timer period may be performed for each take or may be applied uniformly for each shooting angle.

FIG. 14B illustrates a timer selection field 44a displayed in response to the user operation of the timer button 44 on the shooting standby screen of FIG. 14A. FIG. 14B illustrates an example in which the timer period is set to “5 seconds” in the timer selection field 44a. The timer selection field 44a includes options indicating, for example, “OFF” which corresponds to the timer period of zero seconds, and “5 seconds” or the like which indicates a numerical value of the timer period. In step S31, when receiving the user operation in the timer selection field 44a in the user interface 230, the controller 210 sets the timer period according to the user operation, and returns the screen on the display 240 from that of FIG. 14B to that of FIG. 14A.

The controller 210 determines whether or not the timer period is set to a period other than “OFF” in step S72, that is, whether or not the timer setting is ON (S74).

In a case where the timer setting is set to “OFF”, the controller 210 performs various types of control to start shooting and recording of the video of one take associated with the selected shooting angle along with starting the playback of the music track in accordance with the user operation of the recording button 46 (S75). For example, the controller 210 instructs the output sound device determined in step S72 to output the sound in the time range associated with the angle based on the audio data. In step S75, for example, the controller 210 instructs the sound output so that playing the music track for the time range is timed to coincide with the start of the shooting and recording.

On the other hand, in a case where the timer setting is ON (YES in S74), the controller 210 performs various types of control to perform countdown display according to the set timer period in addition to, for example, video recording and music playback in response to the user operation of the recording button 46 (S76). A display example of the electronic device 200 in step S76 is illustrated in FIGS. 14C and 14D.

FIG. 14C illustrates a shooting screen when the recording button 46 is operated in a case where the timer period is set as in the example of FIG. 14B. FIG. 14D illustrates a shooting screen after the timer period elapsed from a state of FIG. 14C. At the time of user operation of the recording button 46 (S76), the controller 210 countdowns a lapse of time for the set timer period, with superimposing the countdown on the displayed live view image, for example. In the present example, the video recording is performed also in such a timer period. In addition, in a case where the timer period is set to “OFF” (NO in S74), in step S75, the controller 210 does not particularly perform the countdown display as illustrated in FIG. 14C, and causes the display 240 to change the screen of FIG. 14A to the shooting screen as illustrated in FIG. 14D, for example (S75).

As illustrated in FIGS. 14C and 14D, for example, the shooting screen in step S76 includes the live view image 45, a recording stop button 46a, and a time display field 49. For example, highlighting such as a frame display indicating that recording is being performed is performed on the live view image 45 on the video shooting screen. The recording stop button 46a receives a user operation for stopping shooting recording of the video. For example, the time display field 49 compares and displays an elapsed time from the start of video shooting of the take and a period of the time range associated with the selected shooting angle.

In step S76, the controller 210 controls the display 240 to switch the display from the shooting standby screen (FIG. 14A) to the shooting screen (FIGS. 14C and 14D). Furthermore, the controller 210 records a video file indicating the live view image 45 sequentially shot by the imager 280 after the user operation of the recording button 46 in the memory 220 (S76).

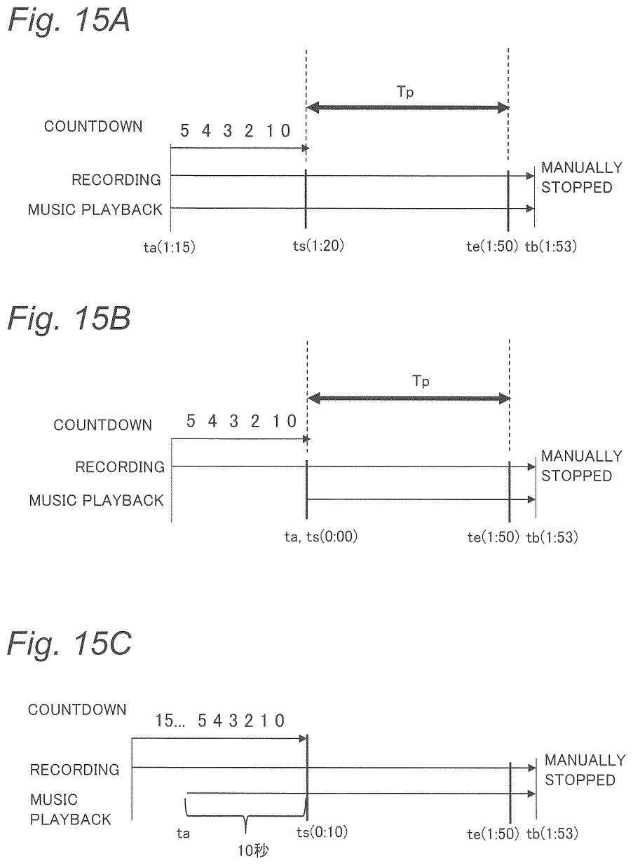

In step S76, in addition to the countdown display as illustrated in FIG. 14C, the electronic device 200 according to the present embodiment plays back music according to a set timer period. FIGS. 15A and 15B are diagrams for describing a timer function in the electronic device 200.

FIG. 15A illustrates an example in which a start time “ts” of a time range Tp set in the angle setting processing (S14 in FIG. 5) is later than a time of beginning of the music track in the audio data for the timer period or more. In the example of FIG. 15A, at the same time as the start of the countdown display, the controller 210 starts to play the music track from the time “ta” before the time range Tp by the timer period, based on the audio data. For example, in step S76, the controller 210 determines the playback start time “ta” in such pre-playback of the music track, based on the time range Tp of the selected shooting angle and the timer period set in step S73.

FIG. 15B illustrates an example in which the start time “ts” of the time range Tp coincides with the time of the beginning of the music. In the example of FIG. 15B, the controller 210 determines the playback start time “ta” of the music track as the start time “ts” of the time range Tp, and performs only the countdown display and the video recording in the timer period. FIG. 15C illustrates an example in which the timer period is set to “15 seconds” and the start time ts of the time range Tp is set to 10 seconds after the beginning of the music. In the example of FIG. 15C, the controller 210 determines the playback start time “ta” of the music track 10 seconds before the start time “ts” of the time range Tp, and further performs the pre-playback of the music track from the playback start time “ta” after the countdown display and the video recording are started in the timer period.

In this manner, in step S76, the controller 210 performs the pre-playback from the start time “ta” at which the music track can be played back, according to the timer period and the start time “ts” of the time range Tp for each shooting angle. Furthermore, in the present example, the video recording and the music playback are performed until the recording stop time “tb” regardless of whether the recording stop time “tb” is later than the end time “te” of the time range Tp from the playback start time “ta”, the recording stop time “tb” being a time at which the video recording is stopped by the user operation of the recording stop button 46a.

Referring back to FIG. 14, the controller 210 performs various types of control to stop video recording and music playback in response to the user operation of the recording stop button 46a (S77). For example, the controller 210 stops video recording of the live view image 45 and stops the sound output (S77). The controller 210 may determine the file name of the video file based on, the shooting angle data D1 and the number of takes shot for the selected shooting angle, for example.

Furthermore, in order to prompt the user to rate the video of the take shot as described above, the controller 210 causes the display 240 to display a rating screen, for example, as illustrated in FIG. 12 (S78).

The controller 210 receives a user operation of the various buttons 41 to 43 on the rating screen as illustrated in FIG. 12, and acquires the user's rating as a result of the rating of the video of the shot take, for example (S79). In the present embodiment, every time a video of one take is shot, the user can arbitrarily select a desired rating from the above three types of rating “OK”, “KEEP”, and “BAD” for a shot video without interfering with rating of a video of another take in particular.

The controller 210 determines, for example, whether or not the rating is “BAD” based on the acquired rating of the user (S80). For example, in a case where the user's rating is “OK” or “KEEP”, the determination in step S80 is “NO”.

When the acquired rating of the user is not “BAD” (NO in S80), the controller 210 sets the shooting completion flag of the shooting angle associated with the take (i.e., the selected shooting angle) in the shooting angle data D1 to “ON” (S81). For example, in the case where the number of takes of the video is “1”, or the case where a rating of a video of an existing take is “BAD” in the number of takes equal to or greater than “2”, the shooting completion flag is switched from “OFF” to “ON” by the execution of step S81.

On the other hand, when the acquired rating of the user is “BAD” (YES in S80), the controller 210 proceeds to step S82 without particularly updating the setting of the shooting completion flag. Thus, when the shooting completion flag of the corresponding shooting angle is in an OFF state when the video having the rating “BAD” is shot, the OFF state is kept, for example. For example, when a video of a take shot in the past has “KEEP” or “OK”, and thus the shooting completion flag is in an ON state, the ON state is kept.

The controller 210 generates metadata of a video of a take shot as described above, and records the metadata in the shooting angle data D1 in the memory 220, for example (S82). The video metadata includes a video file name, rating information, and the like for each take. The controller 210 generates the metadata of the video by including the video file name determined to reflect the number of takes for the video shot in steps S75 to S77, the rating of the user acquired in step S79 in video metadata. The controller 210 stores the generated video metadata in the video metadata list in the shooting angle associated with the video in the shooting angle data D1 (FIG. 9) (S82). The video metadata may include, the number of takes of the video in addition to or instead of the video file name, for example.

For example, controller 210 ends the recording mode processing (S45) by storing the video metadata (S82), and proceeds to step S41 in FIG. 11.

According to the recording mode processing (S45), the electronic device 200 can shoot and record a video of one take for the selected shooting angle with playing the music track for the time range associated with the selected shooting angle, and can prompt the user to rate the video (S75 to S79). According to the timer setting (S73), the electronic device 200 can facilitate shooting a video in accordance with the music track by playing the music track from the time before the time range Tp associated with the shooting angle in addition to the countdown display before the start of the video recording (S76).

The electronic device 200 manages the image shooting completion flag of the angle based on the acquired rating information (S80, S81). In this way, the rating information by the user for each take can be appropriately reflected in the management of whether or not the shooting angle is in the shooting completion state. Furthermore, according to the recording mode processing of the present embodiment (S45), the electronic device 200 can control the shooting and recording of the video to realize the management of the video shooting.

In the rating (S78 to S79) of the video of each take, a plurality of takes of the same rating may be present among a plurality of takes associated with the same shooting angle. For example, a video of a plurality of takes for the same shooting angle may have a rating “OK”.

In addition, the rating screen displayed in step S78 may be displayed as a dialog. For example, the controller 210 may control the display 240 to superimpose and display the dialog of the rating screen on the display screen before and after step S77.

For example, the recording standby screen in the recording mode (FIG. 14A) may further include the return button 15 for a user operation of returning the screen transition to the angle selection screen. The return operation may be a swipe operation in a predetermined one of the +Y direction and −Y direction of the recording standby screen. The electronic device 200 may shift to the playback mode by a swipe operation in the opposite direction to the return operation.

### 2.3. Video Editing Function

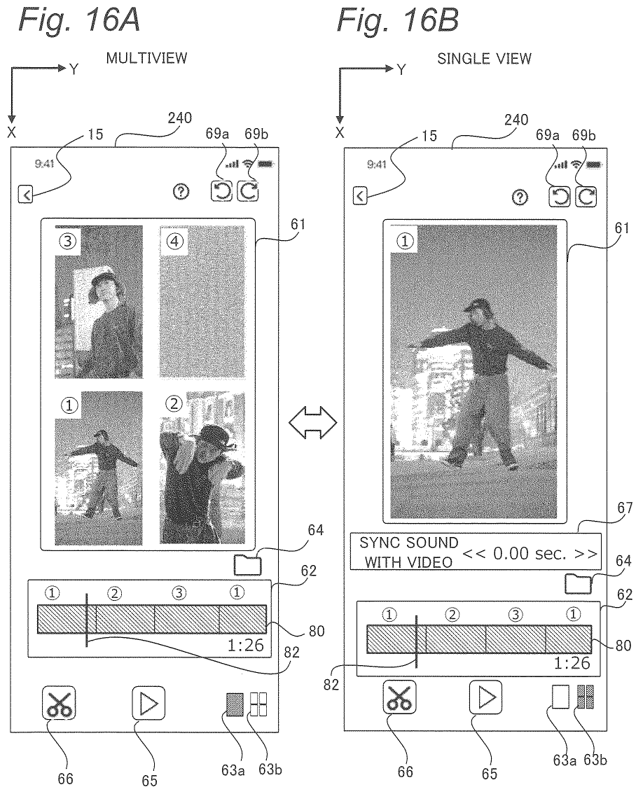

A video editing function in the electronic device 200 of the present embodiment will be described with reference to FIGS. 16A and 16B.

FIGS. 16A and 16B each illustrates a display example of a video edit screen in the electronic device 200. The electronic device 200 reads the video data of the shooting result for each shooting angle by the shooting function, and causes the display 240 to display a video edit screen as illustrated in FIG. 16. The video edit screen is a screen for the user to perform various video editing operations. The video edit screen includes, for example, the multiview screen displaying a list of video data of multiple shooting angles as illustrated in FIG. 16A, and a single view screen displaying video data of one angle as illustrated in FIG. 16B. The single view screen may be used for the user to confirm the edited video work.

Each video edit screen illustrated in FIGS. 16A and 16B includes a material display field 61, a timeline editing field 62, a single view button 63a, a multiview button 63b, a folder icon 64, a video playback button 65, and a cut button 66. For example, as illustrated in FIG. 16B, the single view screen further includes a sound synchronization field 67. Each video edit screen includes a cancel button 69a, a redo button 69b, and the return button 15.

The material display field 61 displays video data read as a material for video editing (i.e., a video material). In the electronic device 200 according to the present embodiment, the material display field 61 displays a preview image in the video material for each shooting angle. The preview image is a representative of a take arranged at each shooting angle from video materials, and an image at timing corresponding to the position of a playback head 82, for example. As illustrated in FIG. 16A, for example, in a case where the video of the angle number “4” is not shot in the shooting function, the material display field 61 does not display the preview image for the shooting angle.

The timeline editing field 62 displays a video timeline 80 in which the video material is arranged along a time axis in the audio data of the music track, and receives the user operation for editing the video work in which the video materials are combined in the video timeline 80. In the example of FIG. 16, the video timeline 80 includes one or more video materials arranged along the time axis in the +Y direction. The playback head 82 moves along the time axis according to a time during playback in the video timeline 80, for example.

The single view button 63a is a virtual button that responds a user operation for switching from the multiview screen (FIG. 16A) to the single view screen (FIG. 16B). Conversely, the multiview button 63b is a virtual button that responds a user operation for switching from the single view screen to the multiview screen. The electronic device 200 according to the present embodiment displays a multiview screen in an initial state, for example, and switches a video edit screen between the multiview screen and the single view screen by operating such the view switching button 63.

The folder icon 64 receives a user operation for changing a take assigned to each shooting angle. The video playback button 65 receives a user operation for playing back the video material of the take arranged at each shooting angle from a timing corresponding to the position of the playback head 82 in the material display field 61. The electronic device 200 according to the present embodiment plays the music track along with playing the video material in response to the user operation of the playback button 65, for example.

The cut button 66 is a virtual button that receives a user operation for dividing the video timeline 80 into a plurality of cuts on the time axis. The respective cuts constitute time domains that does not overlap each other in the video timeline 80. In the electronic device 200 of the present embodiment, for example, video materials of different shooting angles can be assigned to the plurality of divided cuts by the user operation. For example, the timeline editing field 62 displays the angle number of the shooting angle arranged in the initial state or the shooting angle assigned after cutting by the user operation in the video timeline 80.

The sound synchronization field 67 is provided on the single view screen as illustrated in FIG. 16B, and receives a user operation for adjusting association between a time in the audio data of the music track and a time in the video material of the shooting angle displayed in the material display field 61.

For example, on the video edit screen (FIG. 16), the user can adjust the arrangement of the video material in the timeline editing field 62 or arrange a new video material from the material display field 61 in the video timeline 80 with checking the material display field 61. By such a user operation, editing operation of the video work is performed in the electronic device 200.

### 2.3.1. Operation of Video Editing Function

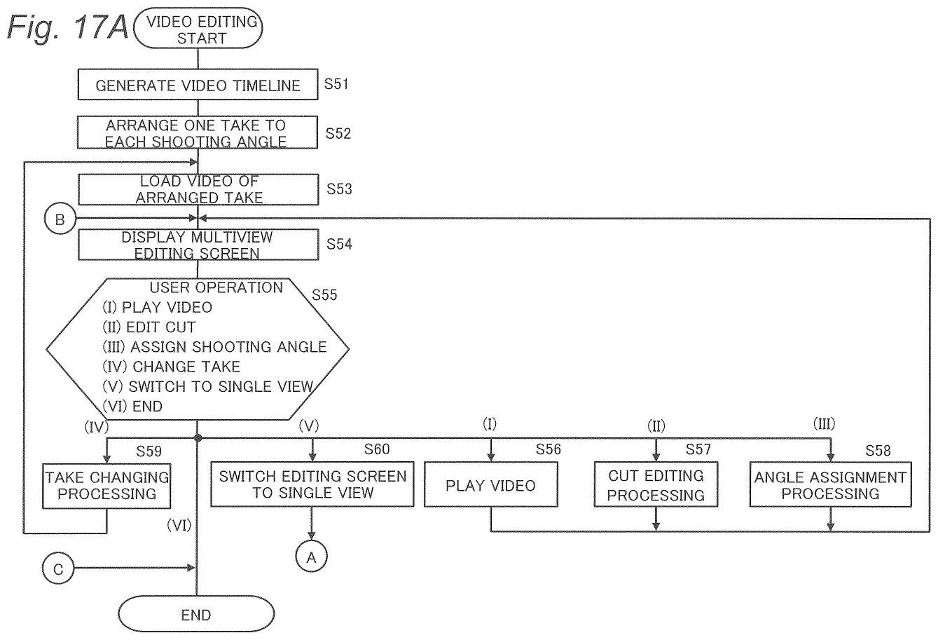

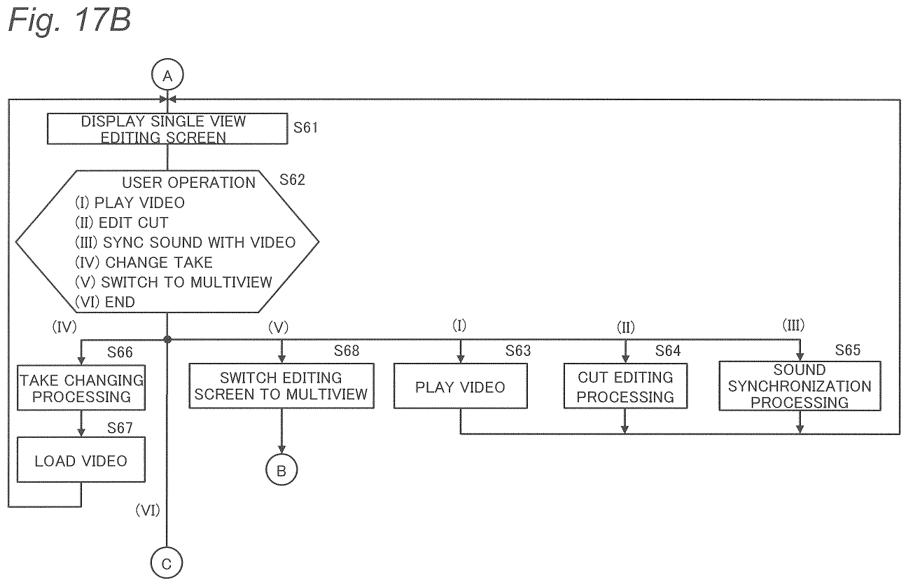

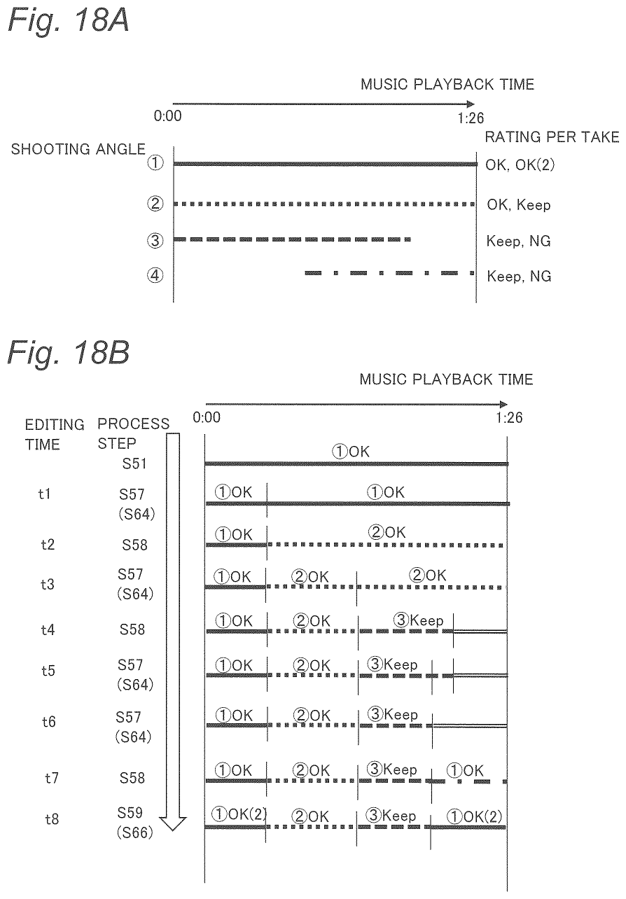

Details of the operation of the video editing function in the electronic device 200 will be described with reference to FIGS. 17A, 17B, 18A and 18B.

FIG. 17A is a flowchart illustrating an operation of the video editing function in the electronic device 200. FIG. 17B is a flowchart illustrating the operation of the video editing function subsequent to FIG. 17A. The processing illustrated in this flowchart is started when the video editing button 13 on the function selection screen (FIG. 1) is operated in a state where the shooting angle data D1 generated by the planning function and the video data recorded by the shooting function are stored in the memory 220 in association with each other by the video metadata, for example. Each processing in this flowchart is executed by the controller 210.

First, the controller 210 generates the video timeline 80 of a period corresponding to the music playback range, for which the music track of the audio data is played in the video work, based on information indicating the time range set in the planning function (FIG. 5) (S51). In this manner, the time range of the video work is associated with the video timeline 80. In step S51, the controller 210 arranges the video material of the angle number “1” in the video timeline 80, referring to the shooting angle data D1, for example.

FIGS. 18A and 18B are diagrams for explaining the video editing function in electronic device 200. FIG. 18A illustrates a relationship between the video material shot for each shooting angle by the shooting function according to the shooting angle data D1 and a music playback time. The music playback time indicates a time in the music playback range of the video work. In this example, for four shooting angles with angle numbers “1” to “4”, two takes are shot for each shooting angle. For example, each take for the respective angle numbers “1” and “2” is shot over the entire music playback range of the video work, and each take for the respective angle numbers “3” and “4” is shot for a partial time range of the music playback range. FIG. 18B illustrates an example in which the video material of FIG. 18A is arranged in the video timeline 80 according to the processing of this flowchart.

Based on the shooting angle data D1, the controller 210 arranges one take to each shooting angle displayed in the material display field 61 of the multiview screen as illustrated in FIG. 16A (S52). For example, the controller 210 arranges a take with the highest rating for each shooting angle based on the rating acquired for each take of each shooting angle on the rating screen (FIG. 12) in the recording mode processing (S45 in FIG. 11, FIG. 13). For example, takes are arranged based on the rating. The ratings are ranked from highest to lowest: “OK”, “KEEP”, and “BAD”. When a plurality of takes has the same rating in one angle, a take whose shooting date and time is the latest among the plurality of takes may be arranged.

The controller 210 reads video data of a take arranged at each shooting angle from the memory 220 as the video material, for example (S53).

### (1) Multiview Screen

The controller 210 causes the display 240 to display the multiview screen to display the preview image of each shooting angle in the material display field 61 based on the read video material (S54).

For example, as illustrated in FIG. 16A, the controller 210 receives various user operations with the user interface 230 such as the touch panel in a state where the multiview screen is displayed on the display 240 (S55). The user operations in step S55 includes (I) a video playback operation, (II) a cut editing operation, (III) an angle assignment operation, (IV) a take changing operation, (V) a switching operation to the single view, and (VI) an exit operation.

The video playback operation ((I) in S55) is a user operation for playing a video from the position of the playback head 82 in the video timeline 80, and is a tap operation of the video playback button 65, for example. When the video playback operation is input on the multiview screen ((I) in S55), the controller 210 simultaneously plays and displays the video material of each shooting angle arranged in the material display field 61 on the display 240 (S56). For example, the controller 210 updates the preview image of each shooting angle according to the lapse of time.

In step S56, the controller 210 controls the speaker 270 or the like to output the sound of the music track from the position of the playback head 82 in the video timeline 80 associated with the music range based on the audio data in parallel with the playback display of the video material. The controller 210 may control the external speaker connected via the communication interface 250 instead of the speaker 270. The controller 210 may cause the output sound device determined in step S72 of the recording mode processing (S45, FIG. 13) output to the sound.

The cut editing operation ((II) in S55) is a user operation related to a plurality of cuts dividing the video timeline 80, and includes a tap operation of the cut button 66, a drag operation of a dividing position, and a long press operation of the dividing position, for example. The dividing position indicates a position corresponding to a boundary between divided cuts in the video timeline 80. For example, when the tap operation on the cut button 66 is input as the cut editing operation ((II) in S55), the controller 210 divides the video timeline 80 into two cuts respectively corresponding to a preceding time domain and a subsequent time domain to the position of the playback head 82 (S57).

In the example of FIG. 18B, one of the takes of the rating “OK” from the video materials of the angle number “1” is arranged in the video timeline 80 (S51), and thereafter, the video timeline 80 is divided into two cuts at an editing time t1 (S57). For example, in such cut editing processing (S57), the same shooting angle as that before the division is assigned to each cut after the division.

Furthermore, when the drag operation at the dividing position is input as the cut editing operation ((II) in S55), the controller 210 moves the dividing position on the video timeline 80 according to the operation (S57). Furthermore, when the long press operation at the dividing position is input as the cut editing operation ((II) in S55), the controller 210 deletes the dividing position and updates the video timeline 80 to combine cuts before and after the dividing position (S57). For example, the video material may be arranged in the combined video timeline 80 according to the video material in a cut before the dividing position (i.e., the cut in −Y direction with respect to the dividing position). Before the dividing position is deleted, a pop-up screen or the like on which the user can select whether or not to continue the deletion may be displayed on the display 240.

The angle assignment operation ((III) in S55) is a user operation for assigning a desired angle to at least one of the divided cuts. For example, the angle assignment operation is an operation of dragging the preview image of the angle selected from the shooting angles in the material display field 61 and dropping the preview image to the vicinity of a cut as an assignment destination among the divided cuts on the video timeline 80. When the angle assignment operation is input ((III) in S55), the controller 210 changes the shooting angle of the cut assigned in the video timeline 80 to the selected shooting angle (S58).

In the example of FIG. 18B, one of the cuts divided at the editing time t1 is changed from the angle number “1” to the angle number “2” by the angle assignment processing (S58) at an editing time t2.

After performing the processing responsive to the above user operations ((I) to (III) in S55) (S56 to S58), the controller 210 returns to step S54 and displays the multiview screen (S54). As a result, the multiview screen is updated to reflect the processing result responsive to each user operation. In this manner, for example, the user can adjust the cut of the video timeline 80 (S57) with listening to sound of the music track and confirming the video material for each shooting angle in the material display field 61 (S56), and assign the video material of a desired shooting angle for each cut (S58).

For example, as illustrated in FIG. 18B, there is a case where an end time point of the video material of the angle number “3”, which is assigned by the angle assignment processing (S58) at an editing time t4, is earlier than the end time point of a cut of the assignment destination. In this case, the video timeline 80 may be automatically divided into two cuts at the end point of the video material, and no shooting angle may be assigned to a cut after the end point of the video material.

In the example of FIG. 18B, the two cuts divided at an editing time t5 are combined by deleting the dividing position in the cut editing processing (S57) at an editing time t6. At this time, the video material with the angle number “3” is shorter than the video timeline 80, and no shooting angle is assigned to a cut after combining, for example. Thereafter, at an editing time t8, the video material with the angle number “1” is assigned to the cut (S58).

The take changing operation ((IV) in S55) is a user operation for changing a take arranged at each shooting angle in the material display field 61. For example, the take changing operation includes an operation of selecting a desired angle by dragging and dropping the preview image onto the folder icon 64, and an operation of selecting a take different from the take being arranged from a take list screen to be displayed on the display 240 according to the user operation. The take list screen is a screen that displays a list of takes of the shooting angle by the preview image or the like. In the take list screen, video playback of each take and re-rating similar to that in the processing in the playback mode (S46 in FIG. 11) may be performed.

When the take changing operation is input ((IV) in S55), the controller 210 switches the take arranged in the material display field 61 to the selected take (S59), and returns to step S53. As a result, the video data of the replaced take is read as the video material (S53). In the example of FIGS. 18A and 18B, the take with the angle number “1” is replaced with another take with the rating “OK” at the editing time t8. In the take changing processing (S59) of the present embodiment, in a state where the same shooting angle is assigned to a plurality of cuts, when the take changing operation is performed for one cut, the controller 210 collectively changes takes of the plurality of cuts, for example.

The switching operation to the single view ((V) in S55) is a user operation for switching from the multiview screen to the single view screen, and is a tap operation of the single view button 63a on the multiview screen, for example. When the switching operation to the single view is input ((V) in S55), the controller 210 switches the video edit screen from the multiview screen to the single view screen (FIG. 16B) (S60). The operation after the change to the single view screen will be described later.

The exit operation ((VI) in S55) is a user operation for ending the video editing function, and is a tap operation of the return button 15, for example. When the exit operation is input ((VI) in S55), the controller 210 changes the screen on the display 240 from the multiview screen to the function selection screen (FIG. 1), and ends the processing shown in this flowchart, for example.

### (2) Single View Screen

The operation of the video editing function on the single view screen will be described with reference to FIG. 17B.

For example, when the switching operation to the single view is input ((V) in S55), the controller 210 switch the video edit screen to the single view screen, referring to the position of the playback head 82 in the video timeline 80 (S60). The controller 210 displays the single view screen to display the preview image of the shooting angle assigned to the position of the playback head 82 in the material display field 61, for example (S61).

For example, as illustrated in FIG. 16B, the controller 210 receives various user operations by the user interface 230 in a state where the display 240 displays the single view screen (S62). The user operations in step S62 includes (I) a video playback operation, (II) a cut editing operation, (IV) a take changing operation, and (VI) an exit operation similar to those in step S55 on the multiview screen. The user operation in step S62 further includes (III) a sound synchronization operation and (V) a switching operation to the single view, instead of the angle assignment operation ((III) in S55) and the switching operation to the multiview ((V) in S55). The operation and processing similar to those of the multiview screen will not be described as appropriate.

The sound synchronization operation ((III) in S62) is a user operation for adjusting a synchronization timing between the time range set in the shooting angle data D1 for each shooting angle and a time in the shot video, and is a tap operation in the sound synchronization field 67 illustrated in FIG. 16B, for example. When the sound synchronization operation is input ((III) in S62), the controller 210 executes sound synchronization processing for the take arranged at the shooting angle being displayed in the material display field 61, for example (S65). In the sound synchronization processing (S65), the association between a time in the time range of the shooting angle and a time in the video material of the take is changed according to the input user operation, for example.

The switching operation to the multiview ((V) in S62) is a user operation for switching from the single view screen to the multiview screen, and is, for example, a tap operation of the multiview button 63b on the single view screen. When the switching operation to the multiview is input ((V) in S62), the controller 210 switches the video edit screen from the single view screen to the multiview screen (S68).

Further, when the video playback operation is input on the single view screen ((I) in S62), the controller 210 plays the music track similarly to step S56 in FIG. 17A, for example, and causes the display 240 to playback and display the video material of the shooting angle being displayed in the material display field 61 (S63). When the cut editing operation is input ((II) in S62), the controller 210 performs the cut editing processing as in step S57 (S64). After performing the processing responsive to the above user operations (I) to (III) in step S62 (S63 to S65), the controller 210 returns to step S61 and causes the display 240 to display the single view screen.

For example, when the take changing operation is input as in (IV) in step S55 ((IV) in S62), the controller 210 performs the take changing processing as in step S59 (S66), and reads video data of the replaced take from the memory 220 (S67). When the exit operation (VI) is input (VI in S62), the controller 210 changes the screen on the display 240 from the single view screen to the function selection screen (FIG. 1), and ends the processing shown in this flowchart.

In each of the video edit screens in the multiview and the single view (FIGS. 16A and 16B), the controller 210 further receives various user operations regarding cancellation of input user operations, via the user interface 230, in addition to the user operations in steps S55 and S62, and executes processing according to the user operations for cancellation. For example, the user operations include a user operation (i.e., undo operation) for canceling the input user operation by tapping the cancel button 69a, and a user operation (i.e., redo operation) for returning a canceled state to a state where the cancelled user operation is input by tapping the redo button 69b.

According to the operation of the video editing function described above, the electronic device 200 can provide the multiview screen and the single view screen as the video edit screen on which the user can easily edit the video of various shooting angles shot according to the plan in accordance with the music track (S51 to S54, S61, FIGS. 16A and 16B). For example, the video edit screen provides the cut editing operation and the angle assignment operation using the video timeline 80 generated corresponding to the music playback range for the video work and the material display field 61 into which the video material for each shooting angle is read ((II), (III) in S55). As a result, for example, the video timeline 80 can be divided by the cut editing processing, for the period of the music playback range shot in the plurality of shooting angles, and the video material of the desired shooting angle can be assigned from the material display field 61 to the divided cut (S55 to S58, S62 to S64).

When a take is arranged at each shooting angle in the material display field 61 (S52), in a case where the time range for the angle number “1” is a period shorter than the period of the video timeline 80, the video material may not be arranged in a period outside the time range, and no shooting angle may be assigned (i.e., the outside period may be a blank state). It may be determined whether or not the period of the time range set to each shooting angle in ascending order of the angle numbers is shorter than the period of the video timeline 80. In a case where a period of any angle number is shorter than that of the video timeline 80, the video timeline 80 may be automatically divided to generate a cut in the black state (i.e., blank cut) for that period.

In step S59 described above, an example is described in which, in a case where the same shooting angle is assigned to a plurality of cuts, takes are collectively switched for the plurality of cuts. The controller 210 may receive the take changing operation ((IV) in S55, (IV) in S62) for each cut, or may arrange video materials of different takes for each cut (S59, S66).

In each of the video edit screens illustrated in FIGS. 16A and 16B, an example is described in which the playback head 82 in the video timeline 80 moves in accordance with playback of a video. The playback head 82 in the video timeline 80 may be fixed to the center in the Y direction, for example, similarly to the playback head 23 in the sound timeline 24. In the video timeline 80, similarly to the sound timeline 24, a period to be displayed may be sequentially updated according to playback of the video, and the period being displayed may be changed according to a user operation such as pinching in and pinching out.

### 3. Summary

As described above, in the present embodiment, the electronic device 200 manages video shooting in accordance with a music track. The electronic device 200 includes: a display 240 that displays information; a user interface 230 as an example of an input interface that inputs a user operation; and a controller 210 that generates shooting angle data D1 as an example of management information managing a video associated with audio data indicating the music track. The controller 210 causes the display 240 to display a time range within the music track indicated by the audio data (S21, S24, S31) and the user interface 230 to receive the user operation setting a shooting angle as an example of a shooting unit for the shooting angle data D1 (S25), the shooting unit during which a video is shot for the time range within the music track. The controller 210 generates the shooting angle data D1 by associating the time range within in the music track with the shooting angle set by the user operation (S33) (S14, see FIGS. 4A and 4B).

According to the electronic device 200 described above, the user can set the shooting angle indicating information on a video shot for the time range within the music track, and it is possible to facilitate management of video shooting in accordance with the music track, by the shooting angle data D1 generated by associating the time range within the music track with the set shooting angle.

In the present embodiment, the controller 210 receives, via the user interface 230, the user operation setting multiple shooting angles to at least a part of the time range within the music track (S14, (I) in S25, see FIG. 7). Therefore, for example, multiple shooting angles can be set to a same time range within the music, for example, by setting the shooting angles to multiple time ranges overlapping with each other, and video shooting corresponding to the time range can be performed for each set shooting angle.

In the present embodiment, the controller 210 receives, via the user interface 230, the user operation designating the time range within the music track corresponding to each shooting angle for each of the multiple shooting angles (S23, (I) in S25). Therefore, the user can designate a desired time range as each time range within the music track corresponding to each shooting angle, and it is possible to facilitate management of video shooting for each shooting angle according to the user's intention.

In the present embodiment, the controller 210 causes the display 240 to display a video edit screen (FIGS. 16A and 16B) as an example of an editing screen for editing the video associated with the audio data (S51 to S54, S61), and the user interface 230 to receive the user operation dividing the music playback range as an example of a video playback period into a plurality of cuts as examples of sections, the video playback period being indicating a time period over which the video is played back with the music track ((II) in S55, S57, (II) in S62, S64, see FIGS. 18A and 18B). The controller 210 assigns the first shot video to the plurality of cuts divided in the video, to update the editing screen, the first shot video being an assigned shot video among a plurality of shot videos for each shooting angle of the multiple shooting angles ((III) in S55, S58, S54). The controller 210 receives, via the user interface 230, the user operation changing the assigned shot video for the plurality of cuts to a second shot video ((IV) in S55, S58, (IV) in S62, S66), to updates the video edit screen according to the change of the assigned shot video (S53 to S54, S67, S61), the second shot video being different from the first shot video among the plurality of shot videos. Therefore, for example, in the video timeline 80, the music playback range of the video work can be divided into a plurality of cuts, and the shot video for different shooting angles can be assigned for each cut.

In the present embodiment, the controller 210 controls video shooting in the shooting angle based on the shooting angle data D1 (FIG. 11, S41 to S47). This facilitates management of video shooting for each shooting angle set in the shooting angle data D1.

In the present embodiment, the electronic device 200 further includes a speaker 270 as an example of an output interface that outputs a sound. Based on the shooting angle data D1 and the audio data, the controller 210 controls the speaker 270 to output, for the video shooting in the shooting angle, a sound in a corresponding time range within the music track associated with the angle, the corresponding time range including the time range associated with the shooting angle (S45, S75, S76). Therefore, the sound of the music track is played back for the corresponding time range associated with the shooting angle in the shooting angle data D1, the user can confirm the corresponding time range within the music track for the shooting angle, and it is possible to facilitate the video shooting in the shooting angle. The electronic device 200 may cause an external speaker or the like connected via the communication interface 250 to output the sound instead of or in addition to the speaker 270.

In the present embodiment, the controller 210 receives, via the user interface 230, for the video shooting in the shooting angle, a user operation designating the timer period as an example of a start time at which the video shooting is started (S73, see FIGS. 14A and 14B), and controls the speaker 270 as an example of the output interface to output, for the video shooting in the shooting angle, a sound for a preliminary period in the audio data according to the designated timer period, the timer period preceding the time range within the music track associated with the shooting angle in the shooting angle data D1 (S74, S76, see FIG. 15). Accordingly, before the video shooting in the shooting angle is started, the user can confirm the sound in the corresponding time range within the music track for the shooting angle according to the timer period. Therefore, it is possible to facilitate adjustment of a timing of starting the video shooting.

In the present embodiment, the shooting angle data D1 includes at least one of the zoom magnification in video shooting in the shooting angle and the shooting direction with respect to a subject in the video shooting. For example, the shooting angle data D1 illustrated in FIG. 9 includes items of “composition” corresponding to the angle icon 3 selected from the preset icons 51 and the like for each zoom magnification and “note” such as a shooting direction input in the note field 53. According to such shooting angle data D1, it is possible to facilitate management of the video shooting in the shooting angle according to the composition or the like set for the shooting angle.

In the present embodiment, a shooting management method for managing video shooting in accordance with a music track is provided. The method includes generating, by the controller 210 of the electronic device 200, the shooting angle data D1 managing a video associated with audio data indicating the music track (S14). The controller 210 is configured to control the display 240 and the user interface 230. Generating the shooting angle data D1 (S14) includes causing the display 240 to display a time range within the music track indicated by the audio data (S21, S24, S31) and the user interface 230 to receive the user operation setting the shooting angle for the shooting angle data D1, the shooting angle during which a video is shot for the time range within the music track (S25), and generating the shooting angle data D1 by associating the time range within the music track with the shooting angle set by the user operation (S33).

In the present embodiment, as an example of a non-transitory computer-readable recording medium, the memory 220 storing a program causing the controller 210 to execute the shooting management method is provided. According to such a shooting management method, it is possible to facilitate management of video shooting in accordance with the music track.

Furthermore, in the present embodiment, the electronic device 200 includes an imager 280 as an example of an image sensor that captures a subject image to generate video data, a memory 220 that stores the shooting angle data D1 managing a video associated with audio data indicating the music track, and a controller 210 that controls video shooting by the imager 280. The shooting angle data D1 includes a time range within the music track in association with a shooting angle set to shoot a video for the time range within the music track in the audio data (see FIGS. 7 and 9). The controller 210 controls the video shooting in the shooting angle based on the shooting angle data D1 (FIG. 11, S41 to S47).

According to the electronic device 200 described above, it is possible to facilitate management of the video shooting in accordance with the music track by controlling the video shooting in the shooting angle, which is set in the shooting angle data D1 in association with the time range within the music track.

Furthermore, in the present embodiment, the electronic device 200 includes the display 240, the user interface 230, the controller 210 that controls the display 240 and the user interface 230, and the memory 220 that stores the shooting angle data D1 managing a video associated with audio data indicating the music track. The controller 210 causes the display 240 to display the video shot in the shooting angle, based on the shooting angle data D1, and the user interface 230 to receive a user operation editing the video associated with the audio data (FIG. 17A, FIG. 17B, S51 to S68).

According to the electronic device 200 described above, it is possible to display the video shot in the shooting angle, which is set in the shooting angle data D1 in association with the time range within the music track, and to edit the video associated with the audio data of the music track. Accordingly, for example, in video editing, it is possible to facilitate management of video shooting according to the music track by using, as the video material, the video shot in the shooting angle corresponding to the time range within the music track.

### Other Embodiments

As described above, the first embodiment is described as an example of the technology disclosed in the present application. However, the technique in the present disclosure is not limited thereto, and can also be applied to embodiments in which changes, substitutions, additions, omissions, and the like are made as appropriate. In addition, it is also possible to combine the components described in the above embodiments to form a new embodiment.

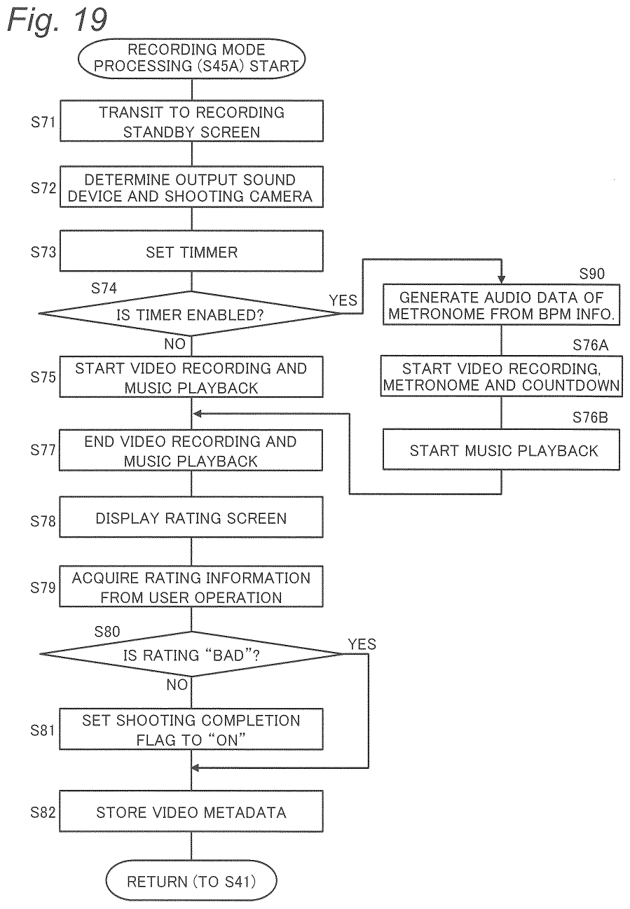

In the first embodiment described above, an example is described in which the electronic device 200 performs the countdown display and the pre-playback of the music track according to the timer setting before playing the music track for the time range for each shooting angle in the recording mode processing of the shooting function (S45) (S76, FIG. 14C, and FIG. 15). The electronic device 200 may output a sound for timing adjustment such as a metronome before play the music track for the time range. Such a modification will be described with reference to FIG. 19.

FIG. 19 is a flowchart illustrating the recording mode processing (S45A) in the modification of the first embodiment. In the present modification, instead of the processing including the pre-playback of the music track (S76) in the recording mode processing of the first embodiment (S45, FIG. 13), a processing including playback of the metronome (S76A) and playback of the music track after the countdown display (S76B) is performed. In addition, in the recording mode processing of the present modification (S45A), in addition to the processing similar to that of the first embodiment, processing related to playback of the metronome is executed (S90).

In the present modification, when the timer setting is ON (YES in S74), the controller 210 of the electronic device 200 generates audio data indicating a metronome sound based on BPM (Beats Per Minute) information of the music track (S90). The BPM information is information indicating a tempo of the music track. For example, a GUI for inputting the BPM information may be provided on various screens in the planning function and/or the shooting standby screen. The controller 210 acquires the BPM information input via the user interface 230 by a user operation on the GUI. Furthermore, the controller 210 may acquire the BPM information by various sound analysis technologies based on the audio data of the music track.

The controller 210 causes speaker 270 or the like to output a sound indicated by generated audio data to play the metronome based on the generated audio data, in addition to starting the video recording and the countdown display similar to step S76 in FIG. 13, for example (S76A). For example, the controller 210 starts playback of the metronome simultaneously with the video recording and the countdown display according to the timer period set in step S73 (S76A).

For example, after the lapse of the set timer period, for the shooting angle being selected as a shooting target, the controller 210 plays back the music track from the start time of the time range set to the shooting angle in the shooting angle data D1, based on the audio data of the music track (S76B).

According to the recording mode processing (S45A), the metronome corresponding to the BPM information of the music is played back in addition to the countdown display (S90, S76A). This also makes it easy to perform timing adjustment at the start of video shooting, and makes it easy to manage the video shooting in accordance with the music track.

In the first embodiment described above, an example is described in which the electronic device 200 displays the angle selection screen on which the shooting target can be selected from the set shooting angles referring to the shooting angle data D1 in the shooting function (S41, S42). The electronic device of the present embodiment may further control the imager 280 and the like in video shooting based on the shooting angle data D1 in the shooting function. For example, the controller 210 may change the zoom magnification or the like in the video shooting according to information indicating the composition for each shooting angle set in the shooting angle data D1.

In each of the above embodiments, an example is described in which the preset icons 51 corresponding to the zoom magnification (or angle of view) is provided as a composition option in the video shooting on the angle edit screen (FIG. 4B) of the electronic device 200. In the electronic device of the present embodiment, for example, without being limited to the zoom magnification, a shooting direction or the like with respect to the subject may be set as the composition for each shooting angle. For example, in the angle edit screen similar to FIG. 4B, a plurality of icons indicating options of the shooting direction may be further provided between the preset icons 51 and the note field 53, or may be provided instead of the preset icons 51. The shooting angle data in the present embodiment may include information indicating the shooting direction or the like in addition to or instead of the zoom magnification as the composition in video shooting for each shooting angle.

In each of the above embodiments, an example is described in which the electronic device 200 divides the video timeline 80 corresponding to the music playback range of the video work into the plurality of cuts in response to the user's cut editing operation ((II) in S55) in the video editing function (S57). In the present embodiment, for example, in the planning function, the electronic device may receive, via the user interface 230, a user operation for specifying a time of the music track assumed to be divided into cuts. For example, the user operation (S25 in FIG. 8A) in the angle setting processing may further include a user operation of a marker or the like for the cut arranged on the sound timeline 24 (see FIG. 4B and FIG. 6) of the playback field 22. In addition to the processing of steps S26 to S28, the controller 210 may acquire cutting information indicating a cutting period designated by the marker operation. The controller 210 may perform cut editing processing referring to the cutting information in generating the video timeline 80 in the video editing function (S51).

In each of the above embodiments, the shooting angle data D1 is described as an example of the management information managing the video associated with the audio data of the music track. The management information of the present disclosure is not limited to the shooting angle data D1, and may be various types of information managed by associating a time range within a music track with a shooting unit such as the shooting angle set by a user operation. The shooting unit of the present disclosure is not limited to the shooting angle described above, and may be various shooting units that can be set by a user operation, the shooting units each indicating information on a video to be shot for the time range within the music track.

In each of the above embodiments, the electronic device 200 having the video shooting function is described, but the electronic device of the present disclosure may be various electronic devices having no video shooting function. For example, the electronic device of the present embodiment may control an imaging apparatus that performs video shooting by various data communication via the communication interface 250 to execute a shooting function similar to that of the first embodiment, or may acquire image data from the imaging apparatus to execute a video editing function.

In the above embodiments, three types of examples in which the rating information is “OK”, “KEEP”, and “BAD” are described, but the rating information is not particularly limited thereto. In the present embodiment, the rating information may be three types of rating different from the above, and is not particularly limited to three types, and may be two types or four or more types. In the present embodiment, the rating information may be a score of a continuous value. The electronic device according to the present embodiment may receive a user input of such various types of rating information and manage video shooting for each shooting angle. For example, the identification display can be performed by appropriately providing a criterion as to whether or not the video shooting of the shooting angle is completed.

### Aspect Examples

Hereinafter, various aspects of the present disclosure will be exemplified.

A first aspect according to the present disclosure is an electronic device for managing video shooting in accordance with a music track. The electronic device includes: a display that displays information; an input interface that inputs a user operation; and a controller that generates management information managing a video associated with audio data indicating the music track. The controller causes the display to display a time range within the music track indicated by the audio data and the input interface to receive the user operation setting a shooting unit for the management information, the shooting unit during which a video is shot for the time range within the music track. The controller generates the management information by associating the time range within the music track with the shooting unit set by the user operation.

A second aspect is the electronic device according to the first aspect, wherein the controller receives, via the input interface, the user operation setting multiple shooting units to at least a part of the time range within the music track.

A third aspect is the electronic device according to the second aspect, wherein the controller receives, via the input interface, the user operation designating the time range within the music track corresponding to each shooting unit for each of the multiple shooting units.

A fourth aspect is the electronic device according to the second or third aspect, wherein the controller causes the display to display an editing screen for editing the video associated with the audio data, and the input interface to receive a user operation dividing a video playback period into a plurality of sections, the video playback period being indicating a time period over which the video is played back with the music track. The controller assigns a first shot video to the plurality of sections divided in the video, to update the editing screen, the first shot video being an assigned shot video among a plurality of shot videos for each shooting unit of the multiple shooting units. The controller receives, via the input interface, the user operation changing the assigned shot video for the plurality of sections to a second shot video, to update the editing screen according to the change of the assigned shot video, the second shot video being different from the first shot video among the plurality of shot videos.

A fifth aspect is the electronic device according to any one of the first to fourth aspects, wherein the controller controls video shooting in the shooting unit based on the management information.

A sixth aspect is the electronic device according to the fifth aspect, further including an output interface that outputs a sound. The controller controls the output interface to output, for the video shooting in the shooting unit, a sound in a corresponding time range within the music track, based on the management information and the audio data, the corresponding time range including the time range associated with the shooting unit.

A seventh aspect is the electronic device according to the sixth aspect, wherein the controller receives, via the input interface, for the video shooting in the shooting unit, a user operation designating a start time at which the video shooting is started. The controller controls the output interface to output, for the video shooting in the shooting unit, a sound in a preliminary period in the audio data according to the designated start time, the preliminary period preceding the time range within the music track associated with the shooting unit in the management information.

An eighth aspect is the electronic device according to any one of the first to seventh aspects, wherein the management information includes at least one of a zoom magnification in video shooting in the shooting unit or a shooting direction with respect to a subject in the video shooting.

A ninth aspect is a shooting management method for managing video shooting in accordance with a music track. The method includes generating, by a controller of an electronic device, management information managing a video associated with audio data indicating the music track. The controller controls a display that displays information and an input interface that inputs a user operation. Generating the management information includes: causing the display to display a time range within the music track indicated by the audio data and the input interface to receive a user operation setting a shooting unit for the management information, the shooting unit during which a video is shot for the time range within the music track; and generating the management information by associating the time range within the music track with the shooting unit set by the user operation.

A tenth aspect is a non-transitory computer-readable recording medium storing a program that causes the controller to execute the shooting management method according to the ninth aspect.

An eleventh aspect is an electronic device for managing video shooting in accordance with a music track. The electronic device includes: an image sensor that captures a subject image to generate video data; a memory that stores management information managing a video associated with audio data indicating the music track; and a controller that controls the video shooting by the image sensor. The management information includes a time range within the music track in association with a shooting unit set to shoot a video for the time range within the music track indicated by the audio data. The controller controls the video shooting in the shooting unit based on the management information.

A twelfth aspect is an electronic device for managing video shooting in accordance with a music track. The electronic device includes: a display that displays information; an input interface that inputs a user operation; a controller that controls the display and the input interface; and a memory that stores management information managing a video associated with audio data indicating the music track. The management information includes a time range within the music track in association with a shooting unit set to shoot a video for the time range within the music track indicated by the audio data. The controller causes the display to display a video shot in the shooting unit, based on the management information, and the input interface to receive a user operation editing the video associated with the audio data.

As described above, the embodiments have been described as an example of the technology in the present disclosure. For this purpose, the accompanying drawings and the detailed description have been provided. Accordingly, some of the components described in the accompanying drawings and the detailed description may include not only essential components for solving the problem but also components which are not essential for solving the problem in order to describe the above technology.

The present disclosure is applicable to various uses for shooting a video in accordance with a music track.

1. An electronic device for managing video shooting in accordance with a music track, the electronic device comprising:
a display that displays information;
an input interface that inputs a user operation; and
a controller that generates management information managing a video associated with audio data indicating the music track, wherein
the controller
causes the display to display a time range within the music track indicated by the audio data and the input interface to receive the user operation setting a shooting unit for the management information, the shooting unit during which a video is shot for the time range within the music track, and
generates the management information by associating the time range within the music track with the shooting unit set by the user operation.

2. The electronic device according to claim 1, wherein
the controller receives, via the input interface, the user operation setting multiple shooting units to at least a part of the time range within the music track.

3. The electronic device according to claim 2, wherein
the controller receives, via the input interface, the user operation designating the time range within the music track corresponding to each shooting unit for each of the multiple shooting units.

4. The electronic device according to claim 2, wherein
the controller
causes the display to display an editing screen for editing the video associated with the audio data, and the input interface to receive a user operation dividing a video playback period into a plurality of sections, the video playback period being indicating a time period over which the video is played back with the music track;
assigns a first shot video to the plurality of sections divided in the video, to update the editing screen, the first shot video being an assigned shot video among a plurality of shot videos for each shooting unit of the multiple shooting units; and
receives, via the input interface, the user operation changing the assigned shot video for the plurality of sections to a second shot video, to update the editing screen according to the change of the assigned shot video, the second shot video being different from the first shot video among the plurality of shot videos.

5. The electronic device according to claim 1, wherein
the controller controls video shooting in the shooting unit based on the management information.

6. The electronic device according to claim 5,
further comprising an output interface that outputs a sound,
wherein the controller controls the output interface to output, for the video shooting in the shooting unit, a sound in a corresponding time range within the music track, based on the management information and the audio data, the corresponding time range including the time range associated with the shooting unit.

7. The electronic device according to claim 6, wherein
the controller
receives, via the input interface, for the video shooting in the shooting unit, a user operation designating a start time at which the video shooting is started, and
controls the output interface to output, for the video shooting in the shooting unit, a sound in a preliminary period in the audio data according to the designated start time, the preliminary period preceding the time range within the music track associated with the shooting unit in the management information.

8. The electronic device according to claim 1, wherein
the management information includes at least one of a zoom magnification in video shooting in the shooting unit or a shooting direction with respect to a subject in the video shooting.

9. A shooting management method for managing video shooting in accordance with a music track, the shooting management method comprising:
generating, by a controller of an electronic device, management information managing a video associated with audio data indicating the music track,
wherein the controller controls a display that displays information and an input interface that inputs a user operation, and
generating the management information includes:
causing the display to display a time range within the music track indicated by the audio data and the input interface to receive a user operation setting a shooting unit for the management information, the shooting unit during which a video is shot for the time range within the music track; and
generating the management information by associating the time range within the music track with the shooting unit set by the user operation.

10. A non-transitory computer-readable recording medium storing a program that causes the controller to execute the shooting management method according to claim 9.

11. An electronic device for managing video shooting in accordance with a music track, the electronic device comprising:
an image sensor that captures a subject image to generate video data;
a memory that stores management information managing a video associated with audio data indicating the music track; and
a controller that controls the video shooting by the image sensor,
wherein the management information includes a time range within the music track in association with a shooting unit set to shoot a video for the time range within the music track indicated by the audio data, and
the controller controls the video shooting in the shooting unit based on the management information.

12. An electronic device for managing video shooting in accordance with a music track, the electronic device comprising:
a display that displays information;
an input interface that inputs a user operation;
a controller that controls the display and the input interface; and
a memory that stores management information managing a video associated with audio data indicating the music track;
wherein the management information includes a time range within the music track in association with a shooting unit set to shoot a video for the time range within the music track indicated by the audio data, and
the controller causes the display to display a video shot in the shooting unit, based on the management information, and the input interface to receive a user operation editing the video associated with the audio data.
